(19) United States
(12) Patent Application Publication
(10) Pub. No.: US 2007/0226621 A1
(43) Pub. Date: Sep. 27, 2007

(54) Computerized advertising method and system

(75) Inventors: Diego Dayan, Buenos Aires (AR); Abel A. Gordon, Haifa (IL); Jorge A. Estevez, Buenos Aires (AR); Federico Alvarez, Buenos Aires (AR); Ivan S. Entel, Buenos Aires (AR); Samuel S. Tenembaum, Punta Del Este (UY)

Correspondence Address: Mr. Daniel Rainer;United Virtualities, Inc., 116 West 23rd Street, New York, NY, 10011, US

(73) Assignee: Porto Ranelli, SA, Punta Del Este (UY)

(21) Appl. No.: 10/662,168

(22) Filed: Sep. 10, 2003

Related U.S. Application Data
(63) Continuation of application No. PCT/US01/28265, filed on Sep. 10, 2001.
(60) Provisional application No. 60/231,404, filed on Sep. 8, 2000.
(60) Provisional application No. 60/257,634, filed on Dec. 21, 2000.

(51) Int. Cl. G06F 3/048

(52) U.S. Cl. 715/706

(57) ABSTRACT

Advertising is presented on a computer screen in the form of an animated multimedia character that will be referred to here as a “Shoshkele™.” The Shoshkele™ appears on the screen in an intrusive way at times which, to the user, are unpredictable, and it is entirely out of his control. The Shoshkele™ can move over the entire screen and is in the top layer of the display of the browser program, so it is not covered up by any window or object. It can also provide sound, including speech, music and sound effects. The sporadic appearance of the Shoshkele™ and its entertainment value draw the attention of the user. The Shoshkele™ character is produced by executeable code provided to the computer, the executeable code being determined by what other executeable code is available on the computer. The present advertising concept and Shoshkeles™ can be realized with existing technology.

This application is a continuation of International application no. PCT/US01/28265, filed Sep. 10, 2001 and claims the benefit of U.S. Provisional Application Ser. Nos. 60/231,404 filed Sep. 8 ,2000 and 60/257,634 filed Dec. 21, 2000, the entire disclosures of which are incorporated herein by reference. The International Application was published in English on Mar. 14, 2002 as WO 02/21238 A2 under PCT Article 21(2).

### FIELD OF THE INVENTION

The present invention relates generally to advertising in new media, such as the Internet and in software programs and, more particularly, relates to method and a system for achieving such advertising.

### BACKGROUND OF THE INVENTION

Users of the Internet are aware of the growing amount of advertising material appearing there. Typically, it is in the form of banners which deliver the advertiser's message. However, the more advertising that appears in this form, the less effective it appears to be. That is because this form of advertising suffers from a number shortcomings. For one thing, the banners are always present and all too similar, so they offer very little interest to the user, and it becomes too easy for a user to ignore them. For another, the user can simply scroll his screen and make them disappear. Banners also take up valuable screen space and cause the screen to be cluttered and overcrowded. There is therefore a need for a much more effective form of advertising with more of an entertainment content.

Originally, most Internet advertisements were just pictures enclosed in a rectangular frame (Banners, pop-up windows), sometimes a single image sufficed, others, the commercial consisted of a sequence of images (animated GIF). Later, a new types of Advertisements were developed that included sound and sometimes interaction. These were given the moniker of rich media, and include Java banners; Interstitials; Superstitials; Flash banners; Shockwave banners and pop-up windows using these technologies or other proprietary ones. Though definitions abound, rich media can be basically defined as any type of advertisement that goes beyond static images. Advertisements that include moving pictures, sound and interaction are generally referred to as rich media advertisements. However, regardless of the technology used, all these formats share a common characteristic: they always exist within a preset shape and usually within a preset size. Whether it is in a frame inside a window, or occupies an entire pop-up, all advertisement units prior to the advent of the present invention inhabit a rectangular space.

In accordance with the present invention, advertising is presented on a computer screen in the form of an animated multimedia character that will be referred to here as a “Shoshkele” character. Shoshkele™ is a trademark and service mark of United Virtualities, Inc., the owner of the present patent application. The Shoshkele™ appears on the screen in an intrusive way at times which, to the user, are unpredictable, and it is entirely out of his control. The Shoshkele™ can move over the entire screen and is in the top layer of an application program display, preferably a browser window, in an operating system such as Windows, so it is not covered up by any window or object. Of course the Shoshkele™ can be in a layer below the top layer if the layers above it are at least partially transparent. It can also provide sound, including speech, music and sound effects. The sporadic appearance of the Shoshkele™ and its entertainment value draw the attention of the user. The present advertising concept and Shoshkeles™ can be realized with existing technologies.

Shoshkeles™ are browser-driven, platform-agnostic, free moving, multi-shaped & sized, audio-visual animations that do not require the download of a plug-in in order to function. A Shoshkele™ character is an audio-visual advertisement: it contains images and sounds that are fully synchronized; it is free floating; it can take any shape, form or size, therefore blending or contrasting with the content; and it works independently of any plug-in, working by utilizing one of many technical solutions available at any given time.

A feature of Shoshkeles™; that distinguishes them from every other type of advertisement, is that all others have predefined shapes and sizes to which the advertisement must conform and to which is confined. They function within a given frame and are limited to it; whether it be a banner frame or an entire window. Unlike anything else, Shoshkeles™ move freely within a browser window independently of content, and without any limitation on shape, form or size. They have no preset boundaries. Shoshkeles™ inhabit any browser window, accompanying the content; but functioning completely independently of it.

This means that Shoshkeles™ need not be taken into account when designing or modifying a page. Nor do they depend on the launch of their own exclusive window. In addition, most rich media products require the download and installation of a plug-in in order to function. If this plug-in is not present, the advertisement server delivers a non-rich media version of the advertisement, which basically consists of an animated GIF, a jpeg or a PNG image. All audio-visual advertisements prior to Shoshkele™ technology required a plug-in. Image only advertisements may not need it. Audio only advertisements may not need it. But the interaction and synchronization of both (sound and picture) has always relied on plug-ins or Java applets. Shoshkeles™ do not, therefore they are universal. They are the only rich media advertisement technology that works regardless of the presence or absence of any specific plug-in, requiring the presence of only a browser supporting JavaScript and Layers (over 99% of the market as of August 2001).

This is made possible by a basic concept supported by a set of tools. This concept is that all multimedia computers that utilize a graphical user interface are inherently capable of displaying a Shoshkele™, though not always utilizing the same technology. It then becomes necessary to determining which technology any given computer supports and how to create a specific advertisement unit tailored to that technology or technologies.

Shoshkeles™ can be distributed in a variety of computerized media, such as wrapware (commercial software), freeware (free software) and shareware (partially free software) and other software categories, Internet websites, as well as any screen-surfaces, whether existing or to be developed (windows, tables, walls, windscreens, garments, etc.).

A cookie identifies the client and a script sorts out different Shoshkeles™ from a database, based upon the client's Shoshkele™ viewing history parameters. The JavaScript script is embedded in a page that executes a FLASH object or animated GIF and the sound. The animation and sound will be synchronized. The sound format could be WAV, MP3, Quicktime, Real Audio, AVI, proprietary, etc., with our without a plug-in. A Shoshkele™ tag is embedded into each web page from a content provider. When the Shoshkele™ tag in a web page is executed, the user is connected to a Shoshkele™ server, and a cookie conveys his/her identity and Shoshkele™ history viewing information. The Shoshkewle server selects the proper Shoskele, based on the client's viewing history and the technology available in his computer. The Shoshkele™ Web model is also applicable to all wireless technologies and operational systems for electrical appliances (PCS, Palm OS, Windows CE, Aperios Sony, General Magic, Set Top Boxes, etc.).

The Shoshkeles™ are marketed in conjunction with Publicity Agencies, Press Agencies, Internet Service Providers (ISP's), Content Providers, etc. In Web Platforms, the pricing can be determined on a CPM basis (Cost per Thousand Impressions) and according to the traffic in the web page in which the Shoshkele™ appears, or by actual clickthroughs to the sponsor site, or on a per second, per user basis, or upon a combination of these.

The users will receive various forms of incentive, such as: Surprise prizes for users who choose to clickthrough at once (“click it or lose it”), or to the user number “n” who clicks through, etc. To enhance interest, the Shoshkeles™ can be programmed in such a way as to tell a story.

Certain software may be sponsored by more than one sponsor. The Shoshkeles™ program can be executed in either Windows, Macintosh, or in the application in question. The Shoshkeles™ appear from time to time, for instance, when opening up a menu, instead of the commands.

In other Non-Web Platforms, such as paid software, the Shoshkeles™ could be less intrusive, taking into consideration that the user actually paid for the software. Thus, in this case, the Shoshkeles™ will enhance productivity, rather than interfere with it. For instance, an Office Assistant featuring a T-shirt with the advertised product).

In all cases the Shoshkeles™ could resemble celebrities (voice and/or image) to enhance the brand awareness of the advertised product.

### BRIEF DESCRIPTION OF THE DRAWINGS

The foregoing brief description, as well as further objects features and advantages of the present invention will be understood more completely from the following detailed description of presently preferred embodiments, with reference being had to the accompanying drawings, in which:

FIG. 1 is a functional block diagram illustrating a system utilizing the present invention;

FIG. 2 is a flowchart illustrating the operation of user monitor 10 in FIG. 1;

FIG. 3 is a flowchart illustrating the process for determining which is to be used to produce a Shoshkele™ on a user's computer;

FIG. 4 is a block diagram illustrating the business model for carrying on computerized advertising in accordance with the present invention;

FIG. 5 is a block diagram illustrating the business model for carrying on a computerized greeting service in accordance with the present invention;

FIG. 6 is a block diagram of a preferred embodiment of the Shoshkele™ Serving System;

FIG. 7, comprising FIGS. 7A and 7B, is a block diagram overview illustrating the operation of the system for serving Shoshkeles™ to users;

FIGS. 8A-8D, also referred to collectively as FIG. 8, constitute flowcharts illustrating how the appropriate Shoshkele™ is selected for a particular user;

FIG. 9, is a block diagram description illustrating how the database tables are used to determine the advertisement to be displayed;

FIG. 10 is a block diagram illustrating the various computers involved in the process described in FIG. 7; and

FIG. 11, comprising FIGS. 11A, 11B, 11C and 11D, is a flowchart illustrating the presently preferred method for communicating with users and distributing multimedia files to them, the function of subsystem 604 of FIG. 6;

### DETAILED DESCRIPTION OF THE PREFERRED EMBODIMENTS

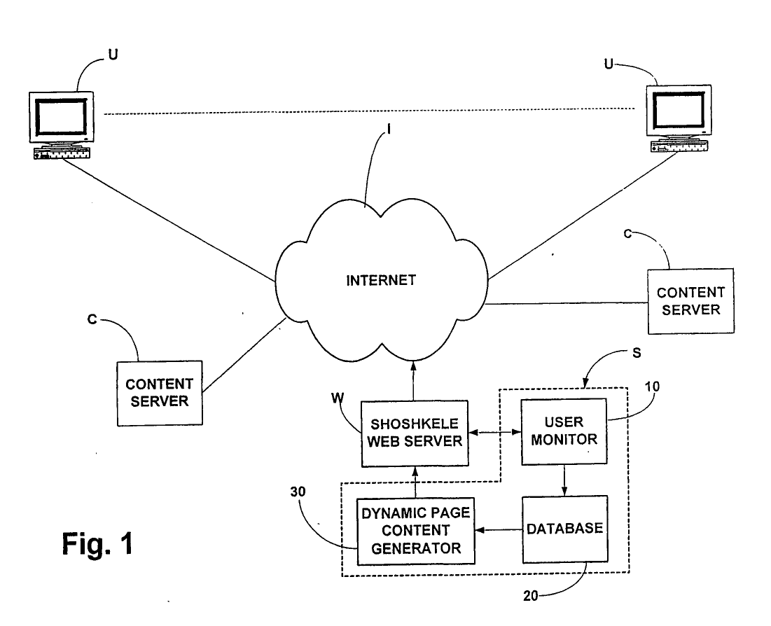

Turning now to the details of the drawings, FIG. 1 is a functional block diagram illustrating a system utilizing the present invention. A plurality of users U communicate as clients with one or more content servers C through the internet I, in order to receive multimedia content from a content provider. Within a web pagereceived from a server C, a user will encounter a tag, which will transfer his computer to the Shoshkele™ web server W. Server W cooperates with or includes the system S embodying the present invention in order to perform the method thereof. The system comprises a website user monitor 10, a database 20 and a dynamic page content generator 30.

In operation, the user monitor 10 monitors access by all users to the webserver W and identifies the users through the use of cookies. The identity of the user is provided to database 20, which provides information about the user to the dynamic page content generator 30, which produces a Shoshkele™ to be inserted the web page being viewed by the user. Monitor 10, database 20 and dynamic page content generator 30 could, although they need not necessarily, be realized as separate software programs running on the same computer as the webserver W.

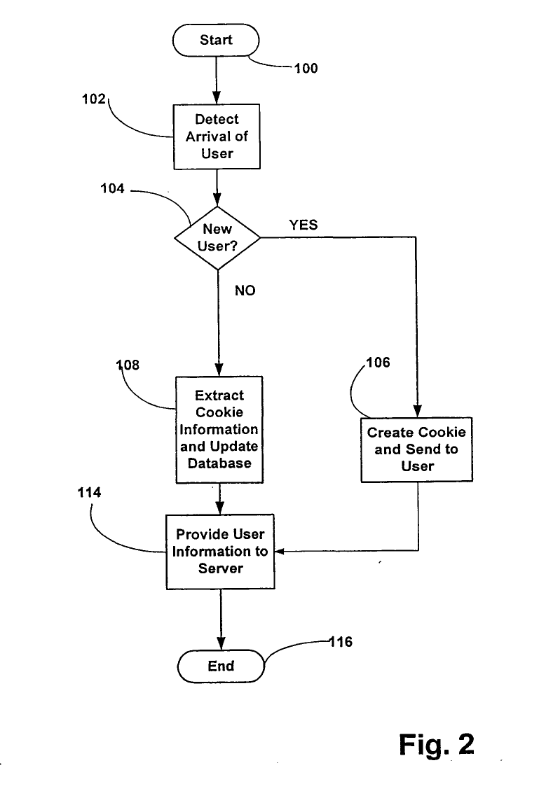

FIG. 2 is a flowchart illustrating the operation of user monitor 10. Operation starts at block 100, with the arrival of the user being detected at block 102. At this point server W preferably sends a JavaScript script to the user, as a result of which his computer is interrogated to locate a Shoshkele™ cookie to determine what technology is present (e.g. the brand and version of his browser software and what plug-ins are installed). Next, it is determined at block 104 whether this is a new user (this would be the case, for example, if he had no Shoshkele™ cookie) and, if so, his computer is sent as Shoshkele™ cookie at block 106. This cookie contains identifying information for the user and a record of recent Shoshkele™ accesses by this user. Thus, before the cookie is sent to the user, it would be updated with information about the Shoshkele™ being prepared for him. Operation terminates at block 116.

If it is determined at block 104 that this is not a new user, Shoshkele™ cookie information is extracted from the user at block 108 and used to update database 20. At this point, the database would receive full information stored in the cookie related to Shoshkele™ accesses by the user. At block 114, user information is provided to the server for the preparation of a Shoshkele™, upon which operation terminates at block 116. It should be appreciated that prior to such termination information about the user's access to the Shoshkele™ would be recorded in his cookie.

The preferred animation software for producing a Shoshkele™ in a web page is Flash by Macromedia. However, as will become clear below, it is contemplated that the Shoshkele™ operate on virtually any computer The Shoshkele™ animation is created in Flash, and the accompanying audio is encoded in MP3 by the Flash program itself from a web original. Then, a public domain JavaScript script is modified to allow it to support and contain any object including animations of different sizes an shapes and to position the Shoshkele™ anywhere on the screen. That JavaScript script inserts a Flash object on the top layer of the display of the browser window, making it unscrollable. Another JavaScript script is also written and inserted which functions to communicate with the Flash object to time its execution (e.g. play twenty seconds after the page is downloaded). This system will only work without intruding on the background page in Internet Explorer versions 4.0 and above, and it must have the Flash plug-in.

As an alternate, technology for producing the Shoshkele™, an animated GIF is acquired by a JavaScript script as in the preceding example, but instead of containing a Flash object it contains a GIF object. In addition a WAV object is acquired by the HTML code. To get the desired time line for the Shoshkele™, a function of the Dreameweaver program called ‘Time line’ is used. Synchronization between GIF and the WAV objects (animation and audio) is achieved through that embedding. All the surrounding area of the GIF will stay transparent, revealing what lies in the layer below. Thus, the viewer sees a character and not a rectangle or rectangular window. This will work with both Internet Explorer and Netscape 4.0 and above and other browsers that have layer technology in them.

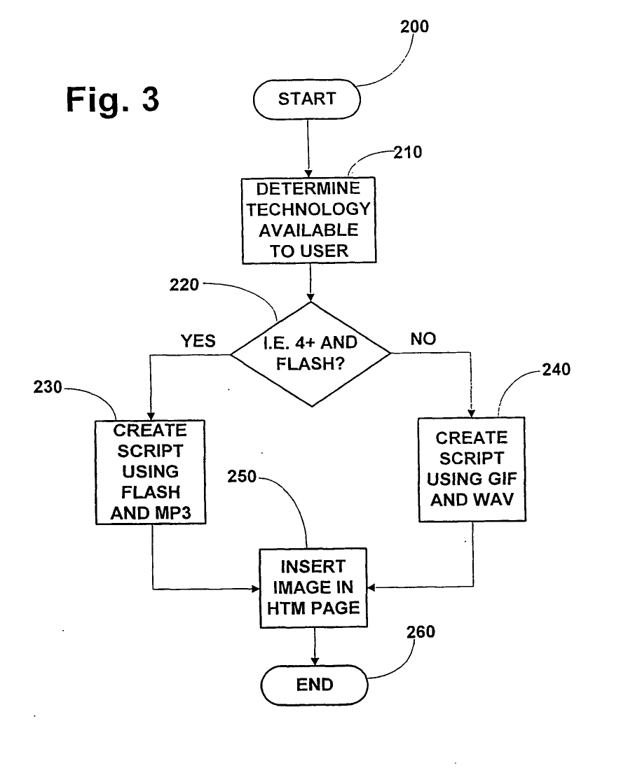

The HTML page provided by server W can access both technologies and will play the first option if all the requisite technology is present in the user's computer or the second one, if they are not. The user will never notice that a choice was made. FIG. 3 is a flowchart illustrating the process determining which script will be used. The process starts at block 200, with a determination being made at block 210 regarding what technology is available in the user's computer to receive the Shoshkele™. If the computer has Internet Explorer 4.0 or higher and Flash, a script is created at block 11 which produces coordinated Flash image containing MP3 or other sound files. If the computer lacks this technology, a script is produced at block 240 which produces an animated GIF file and a synchronized WAV file, as discussed above. At block 250, the appropriate code is generated to produce the Shoshkele™ in the HTML page provided to the user from the server. The process then terminates at block 260.

The original JavaScript script used as a basis for writing the JavaScript scripts Shoshkeles™ is in the public domain, but all modifications were done for the purpose of the present invention and are innovative in their result, i.e. they permit any animation to be played, with different sizes, anywhere on the screen, therefore achieving an unique result: the Shoshkele™.

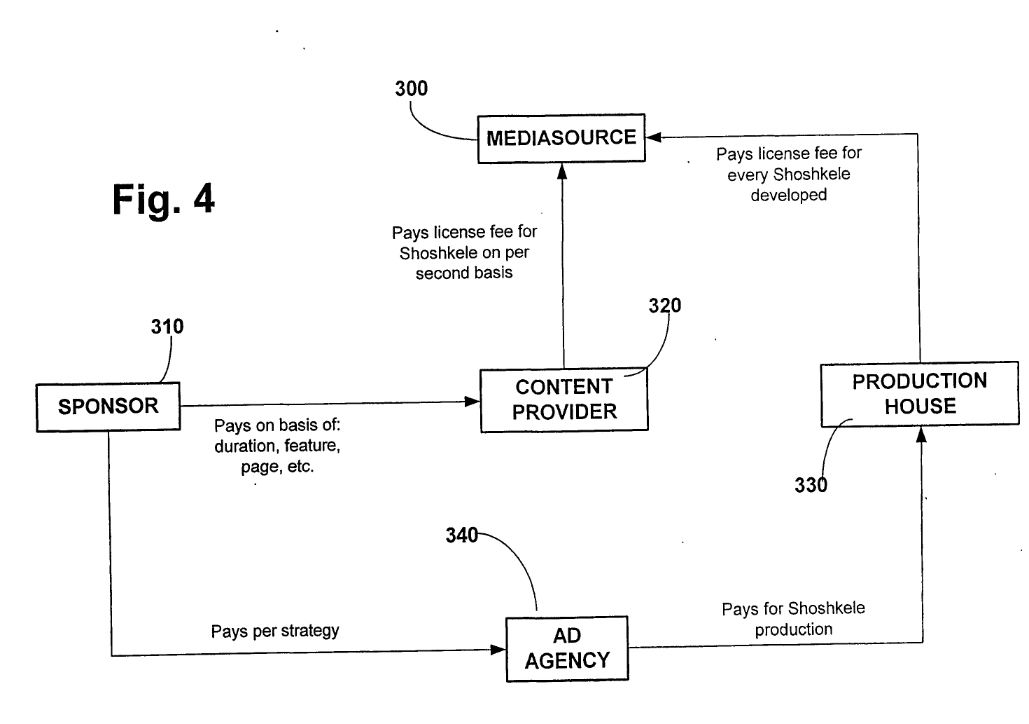

FIG. 4 is a block diagram illustrating a business method for Computerized advertising. It is assumed that the Shoshkeles™ would be made available through an organization 300 called MediaSource.

Marketing of the Shoskeles can be done through advertising agencies 340 which can offer them to their clients (e.g. sponsor 310) to produce commercials (‘shoshmercials’). Agency 340 is paid by Sponsor 310 on a project or “per strategy” basis. The agency 340 pays a production house 310 for the Shoshkele™ production. At a first stage, a Shoshkele™ could be ordered from MediaSource, with prepared scripts. At a later stage MediaSource shall offer a tool kit—‘shoshkelizer’—that will allow the production house 330 or some other subcontractor to build a Shoshkele™ while paying a license fee to MediaSource. Once the Shoshmercial is produced, it would be provided to a user in any page where content provider 320 provided tags for insertion of a Shoshkele™ in content. Preferably, the advertiser would pay MediaSource and agreed fee for creating the Shoshkele™, as well as a per impression fee (one impression=one exposure to one visitor), including a fee for the duration of an impression. MediaSource would deal with the content provider and pay its charges. Alternately, the content provider would pay MediaSource an amount to be decided, per Shoshkele™, and then per impression. All the codes to activate the Shoshkele™ would stay in MediaSource's servers so anyone looking at the source of the page would not be able to copy the Shoshkele™ code.

An example: Budweiser's agency might revert to MediaSource for a five second Shoshkeles™ of a dancing Magic Johnson. The agency might want to have exposure to the southwest american market through Yahoo or another portal (i.e. content provider 320). Agency 340 would furnish MediaSource with the animation in digital media (e.g. prepared by production house 330) complying to MediaSource's specifications. MediaSource would prepare the neccessary coding transforming it to a Shoshkele™, and the webmaster at Yahoo would insert tags Yahoo's page addressed t the Shoshkele™ server. MediaSource shall charge for this X dollars. The Shoshkele™ would be activated until certain codes are sent to it over the Internet. Once the Shoshkele™ is activated, on every Yahoo visit by a recognized southwestern visitor, every time the Shoshkele™ is played, MediaSource shall be paid Y cents. The agency will receive a percentage of MediaSource's revenue for every client it brings to MediaSource.

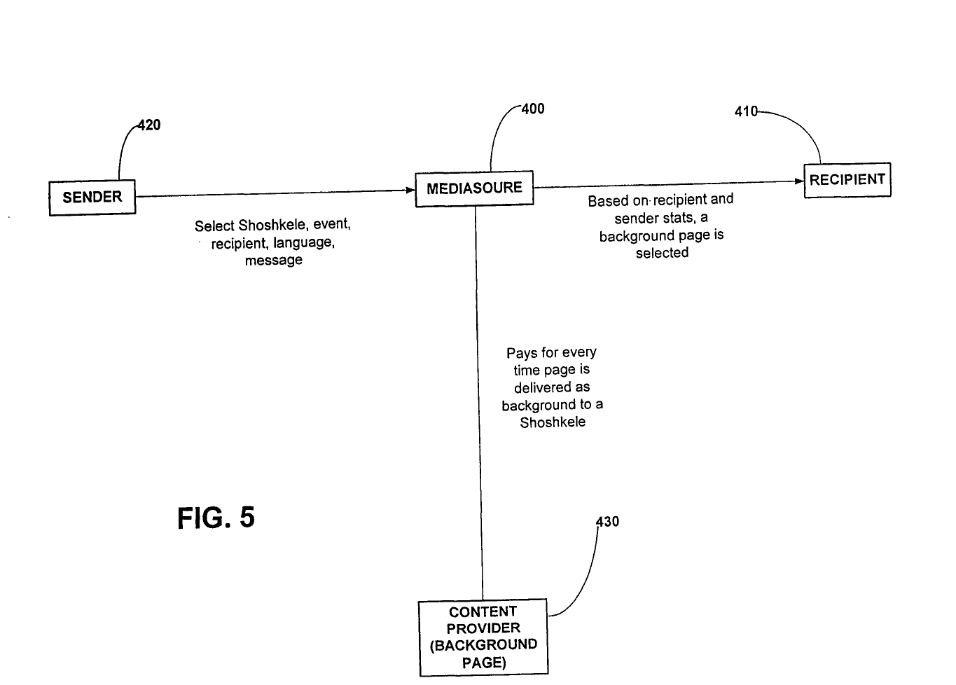

FIG. 5 is a block diagram illustrating a computerized greeting system utilizing Shoshkeles™. Greeting cards are available now on the Internet but are never used in conjunction with background pages from paid advertisement. Building a greeting through a template with options in it, any Internet user will be able to send a greeting Shoshkele™ to another Internet user. This Shoshkele™ will appear on a background on a page in the Internet chosen by MediaSource, not by the visitor, so MediaSource can charge the site for doing so.

### EXAMPLE

An Internet visitor 420 comes to the greeting Shoshkele™ builder home page 400 (MediaSource), where he chooses from a gallery of characters (including his own picture). He then chooses actions and spoken, sung or written messages from a gallery of voices (including the user's own). He enters his own name and email address and identifies the person he wishes to send the greeting Shoshkele™ (name and email address). Then MediaSource's automated system sends an email to the recipient 410 pointing the recipient to a web page (in MediaSource's servers) where he can click and go to receive a greeting Shoshkele™ waiting for him. Arriving there, the recipient sees a regular and/or custom page prepared by an content provider or advertiser 430, for example Yahoo, and the greeting Shoshkele™ appears. MediaSource will have an agreement based on number of impressions, to be paid by the content provider. MediaSource will be charging an additional amount the longer the visitor stays in the background site. Please note that the template could be used to make Shoshkeles™ for the general public, to do advertisement or other things to run on their web sites or others.

Guiding And/or Teaching Shoshkeles™

Shoshkeles™ could appear at Internet sites to guide the user toward features and/or areas and/or other pages, as well as to help in teaching a language, a trade, sex techniques, a dance, martial arts, censorship, reading the news, etc. It may point to mistakes in the use of a computer.

Updating Software

A Shoshkele™ appears on the screen offering to update software that has been outdated, or a plug-in that is missing, or replacing an old one.

Reduced Cost Software (Containing Advertising)

A Shoshkele™ is activated with software downloaded from the Internet or provided on media that will reduce the cost of such software.

### Examples

A user downloads an antivirus program and the free version, when executed, opens a browser window and a Shoshkele™ plays. This may happen every time the antivirus program is updated and/or only once.
An Internet surfer wants to know if a certain person has filed for chapter eleven protection, and a commercial site offering this information allows the downloading of the data or will send it in a diskette or CD ROM, which will be free, while making a profit by attaching to it a Shoshkele™.
International calls are made through the Internet using a microphone and speakers through a dial pad, dialing any place in the world, but the conversation is interlaced at both ends with a Shoshkele™ (may be only sound).

Shoshkeles™ are to the Internet what commercials are to television, meaning that until now all the advertisement done on the Internet was done through banners (similar to ads in magazines or newspapers). On the other hand the Shoshkeles™ since they talk and are human-like, if desired, resemble television commercials.

Special Qualities of Shoshkeles™ Compared to Banners

1. They are not scrollable. That means that if, for example, the Shoshkele™ walks in and says ‘Have a coke’ and the user does not want to see it, the Shoshkele™ cannot be scrolled out, as can a banner. It will stay on the screen until finished.

2. Sound. The only two methods used today on the Internet for advertisement, if at all, are:
MIDI music, which is computer generated sound or
to utilize a special program that must be downloaded (plug-ins or other ) to be able to hear that sound. Example: Flash, You don't know Jack. Shoshkeles™, on the other hand, will play any sound, mono, stereo, music, or talk, on any of the two main browsers (Netscape and Explorer), in their versions 4.0 and above (97.5% of the users today).

3. As opposed to banners, regular users cannot notice in advance that a Shoshkele™ may appear. When a page is opened, until it is fully downloaded, the place of the banner is earmarked, while a Shoshkele™ downloads silently and unobtrusively.

4. Transparency. Banners are not transparent, Shoshkeles™ are not either, but the area immediately around the Shoshkele™ is, and when the Shoshkele™ moves around, every place it moves away from stays fully viewable (transparent). This is different from pop-up windows, which are not. The Shoshkele™ does not have a special window around it. You cannot minimize it or close it. It is in the outer layer of the page.

5. Shoshkeles™ are fully customizable.

### Examples

It could be a celebrity made out of full digital video and sized to fit any requirement. For example, Ricky Martin, Magic Johnson, etc. He could talk (“Have a Pepsi’) or simply have a Pepsi in his hands without saying anything. He could sing and talk or have any sound effect, like steps, door closing, etc., even in stereo, (walking from one speaker to the other).
It could be an animated character. A celebrity such as Bugs Bunny, any cartoon, or cartoon-like person, with all the sound effects, as above.
It could be a shark fin, navigating the written page, with ‘Jaws’ music in the background, finally emerging as the Nike swoosh symbol.
It could be dancing letters from the page the person is viewing with or without sound.
It could be just sound (“Have a Coke’)

6. Fully synchronizable. The meaning of this, is that a Shoshkele™ can be preset to appear once or several times and/or in any time spacing chosen. For example: Ricky Martin can come and say “Have a Pepsi’ and never appear again, or reappear every three minutes, and/or the shark fin (see above) can appear twenty seconds after Ricky Martin has gone. It could last from one second to any length of time chosen. If the page on which the Shoshkele™ appears is minimized, the figure of the Shoshkele™ disappears with the page. If the page is closed both the figure and the voice will disappear.

7. Ease of implementation. It takes less than five minutes for any webmaster to activate or deactivate a Shoshkele™ routine.

8. Interaction with cookies. The Shoshkele™ will interact with cookie technology so:
It may personalize a message (‘Have a Pepsi, Mister Smith’) or (‘Tome usted una Pepsi, Se? or Smith’-Spanish-)
It may recognize that this person has been exposed to this and/or another Shoshkele™ before and when so it might ask ‘Were you scared of the shark?’. It may be used to tell a story in chapters, without appearing too often to become annoying.
It permits the introduction of cookies.

The universality of Shoshkeles™ is made possible by a basic concept supported by a set of tools. This concept is that all multimedia computers that utilize a graphical user interface are inherently capable of displaying a Shoshkele™, though not always utilizing the same technology. It then becomes necessary to determining which technology any given computer supports and how to create a specific advertisement unit tailored to that technology or technologies.

What should be clear is that a Shoshkele™ advertisement unit is not comprised of a single file but by a set of files, and that the key to delivering a working Shoshkele™ is determining which of these files is compatible with a given computer. In order to accomplish this task, there are four steps that need to be fulfilled:
Defining which technologies to support;
Developing matching advertisement units using each technology;
Determining the optimum technology to be sent to each computer; and
Delivering the appropriate files to each computer.

In other words, Shoshkeles™ are made possible not by a single new technology, but by the novel and non-obvious combination of existing ones, along with proprietary code. Depending on the configuration and capabilities of the user's computer, one of the many technological architectures for Shoshkeles™ is chosen, delivered, and executed.

One of the primary difficulties encountered when creating Shoshkeles™, is that each technology or set of technologies has inherent limitations. Some, while being capable of displaying a moving image, are limited to a rectangular shape. Others, cannot carry sound, or can describe sound only. Yet others, require a plug-in, or have different capabilities depending on the platform they run on.

The first problem encountered is that every single object on a web page is defined as a rectangle, therefore limiting all images to being square or rectangular. This explains why, prior to Shoshkele™ technology all advertisement units took that particular shape. This limitation has been overcome by using translucency or transparency, making some parts of the object invisible, usually the portion outside its periphery, thus giving it the appearance of not being of rectangular shape. This, along with locating the objects within floating layers, creates the illusion of a free-moving form of any shape and size.

Certain existing technologies provide a translucency mode (e.g., GIF89), hence making the illusion easier to achieve. However, GIF89 has other limitations, like the lack of sound or interaction capabilities, making it a less than optimal solution for delivering compelling advertisements. Others, have other limitations, such as:
Flash 3—needs a plug-in and has no transparency mode;
Flash 4 and 5—need a plug-in and have no transparency mode on some platforms.
Java Applet—has no transparency mode and is buggy;
Shockwave—needs a plug-in and has no transparency mode on some platforms;
WAV—no image.
GIF—no sound.
JPEG—no sound and no transparency.
PNG—no sound.

These limitations, among many others, motivated the exploration of new altematives, while always using available technology combinations. Always we start with the same basic premise: all multimedia computers are capable of displaying a free floating, multiform, animated advertisement that includes sound. Yet not always by the same means.

Shoshkele™ are made possible through the process by which their architecture is selected. This choice is made by taking into account which of the many alternative Shoshkele™ architectures is best suited for delivering the specific message in the most effective way, depending on each advertisement concept and the technologies available on the end user's computer. The process described below is based on the premise that every single computer connected to the Web contains a collection of tools that, when combined in the right manner, can be used to drive a Shoshkele™.

Also described are the alternative architectures used to deliver and drive Shoshkeles™. These various architectures are designed to overcome the shortcomings of any single technology, such as the lack of synchronized sound, transparency or the reliance on a specific plug-in. A particular architecture is used depending on the inherent characteristics of the Shoshkele™ and the actual configuration of the user's computer.

The creation of a Shoshkele™ is divided in two steps (each divided into sub-steps), that though clearly different are codependent and completely integrated:
Authoring
   Defining which technologies to support
   Developing matching advertisement units using each technology
Serving
   Determining the optimum technology to be sent to each user
   Delivering the appropriate files to each user.

These steps are intimately interwoven and a Shoshkele™ cannot function properly unless they are carefully coordinated. These steps are included in the method herein described and are aided by a set of tools or predetermined process.

### Authoring

Defining Which Technologies to Support

Even taking into account the hundreds of possible technology platform combinations in use-numerous operating systems, browsers, and plug-ins, the present invention manages to keep the number of required Shoshkele™ architectures to a minimum. The accommodated operating systems are as diverse as Windows 95, Windows 98, Windows ME, Windows NT 4.0, Windows 2000, Macintosh System 7, Mac OS 8, Mac OS 9, Mac OS X, several variations of Linux and even the operating system of certain web devices. Most available browsers for each operating system are also accommodated. Capabilities and compatibility issues were a primary consideration.

Shoshkeles™ can by grouped into four major types or families, defined by the availability of the Flash plug-in and its ability to display translucency in a specific browser/platform combination, or the lack of it. The four basic types (with sub-categories) are:
a. Flash with translucency and with MP3 compression
   1) Flash 4 on Internet Explorer 4.0 or better on Windows
   2) Flash 5 on Internet Explorer 4.0 or better on Windows
b. Flash without translucency and with MP3 compression
   1) Internet Explorer 4.0 or better on Mac
   2) Nestcape Navigator 4.0 on all platforms
   3) Opera
c. Flash without translucency and without MP3 compression
d. No Flash.

Type a and its sub-categories allow for the simplest way to author and view Shoshkeles™. The only requirement is an swf file and some proprietary JavaScript code.

Type b and its sub-categories require several solutions, depending on the inherent artistic and technical characteristics of the Shoshkele™. The solution utilized is one of the following:
Flash 4 or 5 (The Shoshkele™ is limited to a square or rectangle on its own layer, which is then hidden and unloaded after the advertisement is finished. All motion is internal, meaning the outer object remains static. The Shoshkele™ pops in, plays, pops out. Fades can be achieved through the alpha channel inside the Flash 4 object)
Flash 4 or 5/Timeline (Same as #1 except the layer is moved by JavaScript code, therefore the square Shoshkele™ can be moved around the browser window freely.
The Shoshkele™ can slide in and out of the window)
Flash 4 or 5/GIF/Timeline (Same as #2, except in this case, the square flash object is wrapped around GIF images that move in synchronism with it, and since GIF does support transparency, the contour can be of any shape, or at least appear that way)
Flash 4 or 5/GIF (Same as #3, minus layer motion.) GIF/Timeline/Flash 4 or 5 (This is a completely different type of Shoshkele™. The picture is made entirely of GIF images, either static or moving. GIFs are placed on their own layer/s that is/are animated through the timeline and synchronized with the sound. Along with Win/Exp/Flash 4 or 5 this is the only option that allows for complete freedom in the shape of the Shoshkele™.

Type c includes every browser that supports Flash, on every platform. This combination has the same limitations, problems and possibilities as Flash 4, except lack of MP3 compression, which means the swf file is somewhat larger. The solutions are the same as with Flash 4 and 5 on platforms that do not support translucency, except it uses Flash 3.

As for type d, the lack of any plug-in entails the synchronization of the native sound format of the system, along with the timeline and one or more animated GIFs in one or more layers.

Following, is a different view of these classifications. It defines Shoshkeles™, not based on their types, but based on the platform/plug-in combinations.
1. Windows (95 or better)
   1.1. Explorer (4.0 or better)
      1.1.1. Flash 4 (Transparency exists, no alternative solutions needed: the Shoshkele™ can take any shape and move within a transparent Flash object sitting on the top layer. When the animation is finished, the layer is hidden and then unloaded). The advertisement is loaded and later unloaded in its own layer, regardless of what is on the rest of the page, allowing for complete freedom in its design & management.
      1.1.2. Flash 3 (No transparency, the Shoshkele™ is limited to a square or rectangle on its own layer, which is then hidden and unloaded after the advertisement is finished)
      1.1.3. Flash 3/Timeline (Same as 1.1.2 except the layer is moved by JavaScript code, therefore the square Shoshkele™ can be moved around)
      1.1.4. Flash 3/Timeline/GIF (Same as 1.1.3. In this case, the square flash object is wrapped around GIF images, and since GIF does support transparency, the contour can be of any shape, or at least appear that way)
      1.1.5. GIF/Timeline/Sound (This is a completely different type of Shoshkele™. The picture is made entirely of GIF images, either static or moving. GIFs are placed on a separate layer that is animated through the timeline and synchronized with the sound.
         1.1.5.1. GIF/Timeline/WAV
         1.1.5.2. GIF/Timeline/Flash 3 (Same as 1.1.6.1 with better compression)
      1.1.6. GIF/WAV (Similar to 1.1.6, except the GIF is a simple animated GIF; it does not move around the screen)
      1.1.7. Flash 3 “The Patch” (This method makes up for the lack of transparency by placing an exact copy of the web page as a backdrop for the flash object. Therefore, when the layer containing the Shoshkele™ comes forth, the user keeps seeing the same image, hence never realizing its been covered by the Shoshkele™)
   1.2. Netscape
      1.2.1. Flash 4 (No transparency, the Shoshkele™ is limited to a square or rectangle on its own layer, which is then hidden and unloaded after the advertisement is finished)
      1.2.2. Flash 4/Timeline (Same as 1.2.1 except the layer is moved by JavaScript code, therefore the square Shoshkele™ can be moved around)
      1.2.3. Flash 4/GIF/Timeline (Same as 1.2.2. In this case, the square flash object is wrapped around GIF images, and since GIF does support transparency, the contour can be of any shape, or at least appear that way)
      1.2.4. Flash 4/GIF (Same as 1.2.3 minus layer motion.)
      1.2.5. Flash 3 (Same as 1.2.1)
      1.2.6. Flash 3/Timeline (Same as 1.2.2)
      1.2.7. Flash 3/GIF/Timeline (Same as 1.2.3)
      1.2.8. Flash 3/GIF (Same as 1.2.4)
      1.2.9. GIF/Timeline/Sound (This is a completely different type of Shoshkele™.
         The picture is entirely made of GIF images, either static or moving. GIFs are placed on a separate layer that is animated through the timeline and synchronized with the sound. Along with Win/Exp/Flash 4 this is the only option that allows for complete freedom in the shape of the Shoshkele™.
         1.2.9.1. GIF/Timeline/WAV
         1.2.9.2. GIF/Timeline/Flash 3 (Same as 1.2.9.1 with better compression)
         1.2.9.3. GIF/Timeline/Flash 4 (Same as 1.2.9.2 with MP3 compression)
      1.2.10. GIF/WAV (Similar to 1.2.9, except the GIF is a simple animated GIF; it doesn't move around the screen)
   1.3. Opera (Same as Netscape)
   1.4. AOL (Same as Netscape)
2. Macintosh (Same as Windows/Nestcape, except a short delay has to be included in the timeline)
3. Playstation
4. WebTV
   Developing Matching Advertisement Units Using Each Technology

Once the analysis is complete, the next step is to create the necessary versions or Shoshkele™ architectures in order for the advertisement unit to work on all desired platforms. Taking into account the artistic considerations for the creative work, 99% of the current web universe can be accommodated by only 9 architectures, although thousands of platform/browser/plug-in combinations are included.

The starting point for all versions is a Shoshkele™ that runs on Internet Explorer version 4.0 or newer with the Flash Plug-in version 4 or newer (hereafter referred to as WE4F4). Owing to the ability of this combination to describe vector and bitmap graphics, animations, sound and translucency; it is the Gold Standard by which all other versions are gauged. This architecture is unequivocally the easiest to author and implement. All others have been developed to emulate the capabilities of this one.

If the obj ective were to develop a Shoshkele™ that functioned only on an HTML page as seen on a IE 4.0 or newer browser with the Flash 4 or newer plug-in (WE4F4) on a computer running Windows, it could be achieved simply by setting the parameter called wmode to transparent on the tag embedding the Flash object on the page:
<param name=“wmode” value=“transparent”>

Since no other platform allows for this solution, all others take a very distinct path. The images and sounds contained in the Flash file are exported into a variety of formats. A JavaScript timeline controls these exported files (MultiMedia Files or MMFs) by creating layers within the HTML document; loading the images and sounds onto those layers; and synchronizing and animating them. These are the raw materials for all Shoshkele™ versions other than WE4F4, the MMFs and the JavaScript code.

The universe of Shoshkele™ architectures is defined by the following nine cases:

| | | |
|---|---|---|
| 1. | Windows IE v4.0 or newer with Flash v.4.0 or newer: | [WE4F4] |
| 2. | Windows IE v4.0 or newer without Flash: | [WE4F0] |
| 3. | Windows Netscape v4.1 or newer without Flash: | [WN4F0] |
| 4. | Macintosh Netscape v4.0 or newer without Flash: | [MN4F0] |
| 5. | Windows Netscape v4.1 or newer with Flash v.4.0 | [WN4F4] |
| | or newer: | |
| 6. | Macintosh Netscape v4.0 or newer with Flash v.4.0 | [MN4F4] |
| | or newer: | |
| 7. | Windows Netscape v6.0 or newer with Flash v.4.0 | [WN6F4] |
| | or newer: | |
| 8. | Macintosh Netscape v6.0 or newer with Flash v.4.0 | [MN6F4] |
| | or newer: | |
| 9. | Macintosh IE v5.0 or newer with Flash v.4.0 or newer: | [ME5F4] |

1. WE4F4

This architecture is implemented with a template in which all that changes is the name of the file and the size. Except for this version, all others have a structure comprising Image files, Sound files and JavaScript controlling code or Timeline.

2. WE4F0

The first step towards having a full range of working Shoshkeles™ covering all platforms is to turn the WE4F4 architecture into one of the Image/Sound/JavaScript architectures. For the sake of process standardization, the first to be created is WE4F0. We call this the HTML Base and the file formats of its MMFs are GIF/AnimatedGIF and WAV. Variations of this HTML Base will be constructed in order to cover the remaining supported platforms.

Step one is to change the HTML Base into an external JavaScript file so that it can be included inside the script tag and transmitted into the page by the document write method. In order to do this all layers from the HTML Base have to be pasted right after the <script language=“JavaScript”>tag:

```
<div id=”skltrama” style=”position.. [etc, etc, etc...]
<div id=”sklbanner” style=”position:absolute; left:499px; top:63px;
width:21px; height:5px; z-index:5; visibility: hidden”><a
href=”http://www.aimovie.com”>
<img src=”skl_g_variety_aibanner.jpg”
width=”202” height=”44” border=”0”></a></div>
function MM_findObj(n, d) { //v4.0
  var p,i,x; if(!d) d=document;
  if((p=n.indexOf(”?”))>0&&parent.frames.length) {
    d=parent.frames[n.substring(p+1)].document;
    n=n.substring(0,p);}[etc, etc,
```

The objective is to preserve the layers without writing them from the HTML but from the JavaScript.

Next, the layer is placed in a variable:

var SH_Lay=’<div id=”skltrama” style=”position:absolute; left:268px;
top:37px;
width:26px; height:21px; z-index:1; visibility: hidden”><img
src=”skl_aicircu01.gif” width=”413” height=”413 ”
name=”sklimgtrama”></div>’
document.write (SH_Lay);

This is the base JavaScript timeline, all versions will evolve from this one.

The next addition is a new variable pointing to the MMFs called “the SRC”

Var theSRC=’http://akamai.com/imagenes/’
var SH_Lay=’<div id=”skltrama” style=”position:absolute; left:268px;
top:37px;
width:26px; height:21px; z-index:1; visibility: hidden”><img
src=”skl_g_aicircu01.gif” width=”413” height=”413”
name=”sklimgtrama”></div>’

In this example we see that the image called skl_g_aicircu01. gif does not have a location assigned to it. In order to be able to point the browser to a particular URL or directory the variable the SRC is ante-posed to the name of the image.

var SH_Lay=’<div id=”skltrama” style=”position:absolute; left:268px;
top:37px;
width:26px; height:21px; z-index:1; visibility: hidden”><img
src=”’+theSRC+’skl_g_aicircu01.gif” width=”413” height=”413”
name=”sklitrama”></div>’

By doing this with all images and sounds we end up with a very flexible file that can easily locate its MMFs.

Since the JavaScript code makes calls to external MMFs it is necessary not only for the timeline to load but also for the MMFs to complete loading before execution begins. We ensure this by adding the following code.

window.onload=shcreate;

This tells the browser to execute the shcreate function only when the page completes loading, thus avoiding the display of a Shoshkele™ before all MMFs are available.

The problem lies in that the browser will trigger the function as soon as it loads the elements it is aware of, which are not all of them. Some MMFs which are not in a layer yet will not be cached by this command. The trick here is that some images are not yet inside the layers, hence we need to implement some way to preload them. After identifying them, we can instruct the browser to preload them with the following modification to our timeline:

var theSRC=”;
var SH_Lay=’<div id=”skltrama” [etc, etc...]><img
src=”’+theSRC+’skl_g_aicircu01.gif”[etc, etc...]>/div>’
+’<div id=”sklpibe”[etc, etc...]>
<img src=”’+theSRC+’skl_g_aisecuencia.gif”
[etc, etc...]border=”0”></div>’
+’<div id=”sound”[etc, etc...]><embed src=”’+theSRC+’skl_s_ail2.wav”
autostart=”false”></embed></div>’
+’<div id=”texto”[etc, etc...]><font size=”5”>ARTIFICIAL
INTELLINGENCE</font></font></font></p></div>’
+’<div id=”sklbanner”[etc, etc...]<img
src=”’+theSRC+’skl_g_variety_aibanner.jpg” width=”202” he></a>
</div>’;
document.write(SH_Lay);
MM_preloadImages (theSRC+’Skl_g_aicircu05.gif’,
theSRC+’Skl_g_aicircu04.gif’,
theSRC+’skl_g_aicircu02.gif’, theSRC+’skl_g_aicircu03.gif’,
theSRC+’skl_g_aicircu06.gif’);

The handling and preloading of the sound files present other considerations. Through the EMBED function we insert the audio file onto the page, and since we need to control playback, the AUTOSTART property must be set to FALSE.

In order to begin playback, the Flash plug in allows for the play( ) method, hence:

<HTML>
<EMBED NAME=”soyunsonido” src=”elSonido.wav”
autostart=”false”></EMBED>
<SCRIPT LANGUAGE=”JavaScript”>
document.soyunsonido.play( );
</SCRIPT>
</HTML>

For those cases that do not support the play( ) command (those in which the sound file is in another format), the solution is to overwrite the layer changing the AUTOSTART setting from FALSE to TRUE.

Original

<EMBED SRC=”thebeatles.wav” autostart=”false”>

Overwritten

<EMBED SRC=”thebeatles.wav” autostart=”true”>

The flaw with this method is that the embedded sound cannot be overwritten, the solution is to do it inside a layer.

<div id=”sound”><embed src =”skl_s_ail2.wav” width=”32 ”
height=”32” autostart=”false”></embed></div>

It is at this stage that most of the adjustments needed to make the different versions take place. In order for the previous operation to work on Netscape the layer must be visible, hence, the layer must be located off screen in order for the sound controller to remain out of sight.

<div id=”sound” style=”position:absolute; left:0px; top:-300px;
visibility:visible;”>
<embed src=”‘+theSRC+’skl_s_ai12.wav” width=”32” height=”32”
name=”snd” autostart=”false”></embed>
</div>

The sound file is now ready to be executed at will. There are different methods to overwrite the contents of a layer depending on the browser.

3. WN4F0

Although very similar to the Explorer version, in this case the <DIV>tag has to be replace by the <LAYER>tag. Theoretically, on Netscape 4.0 or newer browsers both tags are accepted, but experience shows that when using the document.write method the <DIV>tag may result in errors.

var SH_Lay=‘<layer id=”skltrama” style=”position:absolute;
left:268px; top:37px; width:26px; height:21px; z-index:1; visibility:
hidden”><img
src=”‘+theSRC+’skl_g_aicircu01.gif” width=”413” height=”413”
name=”sklimgtrama”></layer>’

Now, since the <LAYER> tag does not support STYLE, it is removed.

var SH_Lay=‘<layer id=”skltrama”><img src=”‘+theSRC+
’skl_g_aicircu01.gif” width=”413” height=”413”
name=”sklimgtrama”></layer>’

Next, the properties are set.

var SH_Lay=‘<layer id=”skltrama” LEFT=”268” TOP=”37”
WIDTH=”26” HEIGHT=”21” Z-INDEX=”1”
VISIBILITY=”VISIBLE”><img
src=”‘+theSRC+’skl_g_aicircu01.gif” width=”413” height=”413”
name=”sklimgtrama”></layer>’

Note that on Netscape all layers have absolute positioning, therefore eliminating that setting. Also, top/left/width/height are measured in pixels, doing away with “px”. Finally, HIDE replaces HIDDEN.

This changes must be made to all layers as coded in version WN4F0:

var theSRC=”;
var SH_Lay=‘<LAYER id=”skltrama” LEFT=”268” TOP=”37” WIDTH=”26”
HEIGHT=”21” Z-INDEX=”1” VISIBILITY=”HIDE”><img
src=”‘+theSRC+’skl_g_aicircu01.gif” width=”413” height=”413”
name=”sklimgtrama”></LAYER>’
+‘<LAYER id=”sklpibe” LEFT=”390” TOP=”139” WIDTH=”15” HEIGHT=”20”
Z-INDEX=”2” VISIBILITY=”HIDE”><img
src=”‘+theSRC+’skl_g_aisecuencia.gif” width=”166” height=”169”
name=”sklimgpibe” border=”0”></LAYER>’
+’<LAYER id=”sound” LEFT=”0” TOP=”−300” WIDTH=”11” HEIGHT=”11” Z-
INDEX=”3” VISIBILITY=”VISIBLE”><embed src=”‘+theSRC+’skl_s_ai12.wav”
width=”32” height=”32” name=”snd” autostart=”false”></embed></LAYER>’
+‘<LAYER id=”texto” LEFT=”335” TOP=”295” WIDTH=”283” HEIGHT=”14”
Z-INDEX=”4” VISIBILITY=”HIDE”><p align=”center”><font face=”Times New
Roman, Times, serif” size=”2” color=”#FFFFFF”><b><font size=”4”>A
STEVEN SPIELBERG FILM<br></font></b><font size=”4”><font size=”5”>ARTIFICIAL
INTELLINGENCE</font></font></font></p></LAYER>’
+‘<LAYER id=”sklbanner” LEFT=”499” TOP=”63” WIDTH=”21” HEIGHT=”5”
Z-INDEX=”5” VISIBILITY=”HIDE”><a href=”http://www.aimovie.com”><img
src=”‘+theSRC+’skl_g_variety_aibanner.jpg” width=”202” height=”44”
border=”0”></a></LAYER>’;

4. MN4F0

This version is exactly like the previous one with the caveat that the sound files must be in the AIFF format instead of WAV. The layer should look like this:

+‘<LAYER id=”sound” LEFT=”0” TOP=”−300” WIDTH=”11”
HEIGHT=”11” Z-INDEX=”3” VISIBILITY=”VISIBLE”><embed
src=”‘+theSRC+’skl_s_ai12.aif” width=”32” height=”32” name=”snd”
autostart=”false”></embed></LAYER>’

and the timeline, like this:

document.MM_Time[0][15].value =
”MM_showHideLayers(‘sklpibe’,”,‘show’);-
MM_setTextOfLayer(‘sound’,”,‘%3Cembed
src=%22‘+theSRC+’skl_s_ai12.aif%22 autostart=%22true%22
hidden=%22true%22%3E%3C/embed%3E’)”;

5. WN4F4

For this version, instead of using a WAV sound, advantage will be taken of the MP3 encoding capabilities of the Flash 4 or newer plug-in. By sending the sound inside an swf file (Flash) it is possible to reduce its size and the overall Shoshkele™ combined file size. It must be remembered that even though this version utilizes the Flash plug-in, it does so only to transmit sound, though not images. The Flash plug in does not support the TRANSPARENT setting on this platform, forcing us to use GIF images in order to display non-rectangular objects.

To implement this, a preload is added to the swf containing the soundtrack, and from within it a call is made to a the sh_cargar( ) function. On the sh-create( ) function the sound layer is dynamically written using the swf sound. Next the sh_create( ) function is created and instructed to start timeline execution when implemented. This is what the shcreate function looks like on the original JavaScript code:

function shcreate( ) {
MM_timelinePlay(’shtimeline’);
}

and this is what it should look like on this Shoshkele™ architecture:

function shcreate( ) {
MM_setTextOfLayer(‘sound’,”,‘<embed src=”‘+theSRC+’-
skl_s_ai12.swf” quality=high
pluginspage=”http://www.macromedia.-
com/shockwave/download/index.cgi?P1_Pr
od_Version=ShockwaveFlash” type=”application/x-shockwave-flash”
width=”152” height=”115” loop=”false”></embed>’);
}

The properties within the EMBED are simply indicate the file format to the browser. The shcreate function loads the swf file into the SOUND layer. As coded, this file calls onto the sh_cargar function after it has loaded, therefore all that's left is the programming of such function so that it starts the timeline as it begins playback.

function sh_cargar( ) {
MM_timelinePlay(’shtimeline’);
}

In other words, the sh_cargar function performs the same duty as shcreate does on other versions.
ONLOAD -->shcreate -->swf sound -->sh_cargar-->Timeline execution.

After modifying shcreate and adding sh_cargar, delete the original content of the SOUND layer. Also, delete the call to MM₁₃ setTextOfLayer found on Frame

+‘<LAYER id=”sound” LEFT=”0” TOP=”−300” WIDTH=”11”
HEIGHT=”11” Z-INDEX=”3” VISIBILITY=”VISIBLE”></LAYER>’

6. MN4F4
   Compatible with WN4F4.
7. WN6F4

This architecture is a hybrid between WE4F4 and WN4F4. It shares code with both, yet more so with Explorer. For this reason, starting with the WE4F0, it must be modified to use an swf file for the sound format. This is done in the same manner as before. Delete the embedded content in the SOUND layer:

<embed src=”’+theSRC+’skl_s_ai12.wav” width=”32”
height=”32” name=”snd” autostart=”false”></embed>

The layer should look something like this:

+’<div id=”sound” style=”position:absolute; left:0px; top:-300px;
width:11px; height:11px; z-index:3; visibility: visible”></div>’

Next, delete the MM₁₃ setTextOfLayer call on Frame 1 of the timeline:

MM_setTextOfLayer(’sound’,”,’%3Cembed
src=%22’+theSRC+’skl_s_ai12.wav%22
autostart=%22true%223E%3C/embed%3E’)

This is what it should end looking like:

document.MM_Time[0] [15] = new String(”behavior”);
document.MM_Time[0] [15].frame = 1;
document.MM_Time[0] [15].value =
”MM_showHideLayers(’sklpibe’,”,’show’);”;
document.MM_Time[0] [16] = new String(”behavior”);

Modify the shcreate function and add sh_cargar( ) so that that the resulting code looks as follows

```
function shcreate( ) {
  MM_setTextOfLayer(’sound’,”,’<embed
src=”’+theSRC+’skl_s_ai12.swf”
quality=high
pluginspage=”http://www.macromedia.com/shockwave/download/
index.cgi?P1_Pr
od_Version=ShockwaveFlash” type=”application/x-shockwave-flash”
width=”152” height=”115” loop=”false”></embed>’);
}
function sh_cargar( ) {
  MM_timelinePlay(’shtimeline’);
}
```

8. MN6F4
   Same as WN6F4.
9. ME5F4

As a starting point take either Netscape 6 version. Instead of VISIBILITY, DISPLAY is used along with the parameters NONE or INLINE. It should also be noted that it is not necessary to modify the sound layer, since its visibility does not change.

var SH_Lay=’<div id=”skltrama” style=”position:absolute; left:268px;
top:37px; width:26px; height:21px; z-index:1; display: none”><img
src=”’+theSRC+’skl_g_aicircu01.gif” width=”413” height=”413”
name=”sklimgtrama”></div>’
+’<div id=”sklpibe” style=”position:absolute; left:390px; top:139px;
width:15px; height:20px; z-index:2; display: none”><img
src=”’+theSRC+’skl_g_aisecuencia.gif” width=”166” height=”169”
name=”sklimgpibe” border=”0”></div>’
+’<div id=”sound” style=”position:absolute; left:0px; top:-300px;
width:11px; height:11px; z-index:3; visibility: visible”><embed
src=”’+theSRC+’skl_s_ai12.wav” width=”32” height=”32” name=”snd”
autostart=”false”></embed></div>’
+’<div id=”texto” style=”position:absolute; left:335px; top:295px;
width:283px; height:14px; z-index:4; display: none”><p align=”center”>
<font face=”Times New Roman, Times, serif” size=”2”
color=”#FFFFFF”><b>
<font size=”4”>A STEVEN SPIELBERG FILM<br></font></b>
<font size=”4”><font size=”5”>ARTIFICIAL INTELLINGENCE
</font></font></font></p></div>’
+’<div id=”sklbanner” style=”position:absolute; left:499px; top:63px;
width:21px; height:5px; z-index:5; display: none”><a href=”http://www.-
aimovie.com”><img src=”’+theSRC+’skl_g_variety_aibanner.jpg”
width=”202” height=”44” border=”0”></a></div>’;

After modifying the layers, all that's left is replacing the MM₁₃ showHideLayers function for this other one:

function MM_showHideLayers( ) {
var i,p,v,obj,args=MM_showHideLayers.arguments;
for (i=0; i<(args.length-2); i+=3) if ((obj=MM_findObj(args[i]))!=null) {
v=args[i+2];
if (obj.style) { obj=obj.style; v=(v==’show’)?’inline’:(v=’hide’)?
’none’:v; }
obj.display=v; }
}

Underlayer Option.

Following is a variation on the described technique that allows for the creative to float underneath the content as opposed to over it. This capability adds to the arsenal of options Shoshkele™ technology supports. In order to achieve this, we use the z-index parameter and instruct the browser to place the Shoshkele™ behind the content.

<STYLE TYPE=”text/css”>body {position:absolute;z-index:1;}</STYLE>
<DIV ID=”PEPSI” STYLE=”position:absolute;z-index=−1;”>TEXT
OR IMAGES HERE</DIV>

### Serving

Once the Shoshkele™ files have been defined and created, in order for the advertisement unit to work they must be sifted and served to the computer they were designed for. This step is just as crucial as the authoring one, since an error here would cause the malfunction of the Shoshkele™ or even the entire page containing it.

In order to ensure operation two procedures must take place: determining the optimum technology for a given user; and delivering the appropriate files to such user. These procedures can be performed by many logical processes and several different technologies. Both capabilities have been built into a single system called Shoshkele™ Serving System.

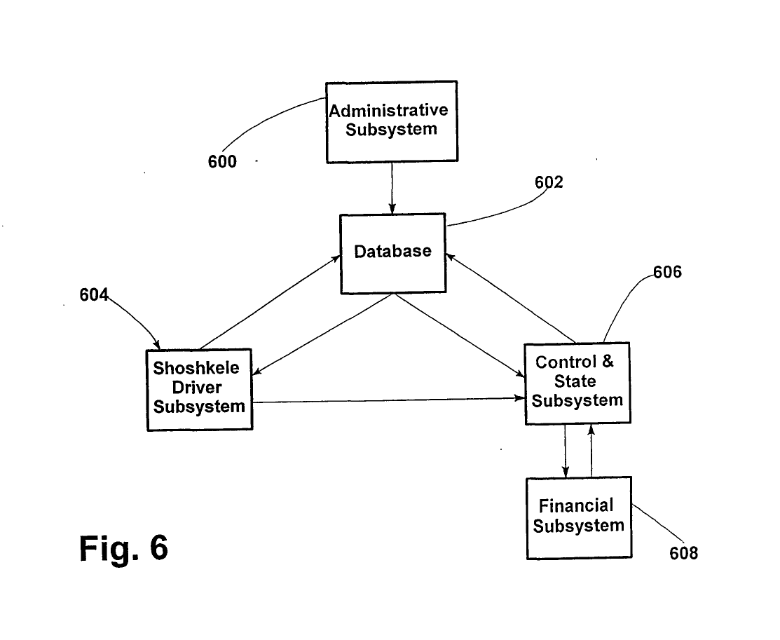

As seen in FIG. 6, the Shoshkele™ Serving System is divided into four subsystems: Shoshkele™ Driver Subsystem; Administrative Subsystem; Control and Statistics Subsystem; and the Financial Subsystem. Of these subsystems, the Shoshkele™ Driver Subsystem is at the heart of Shoshkele™ technology. It determines which advertisement must be delivered to each user on each page. The Shoshkele™ Driver Subsystem deals with all functions that pertain to the actual Shoshkeles™ selection and delivery. It chooses the advertisement to be delivered, and the Shoshkele™ architecture to be used.

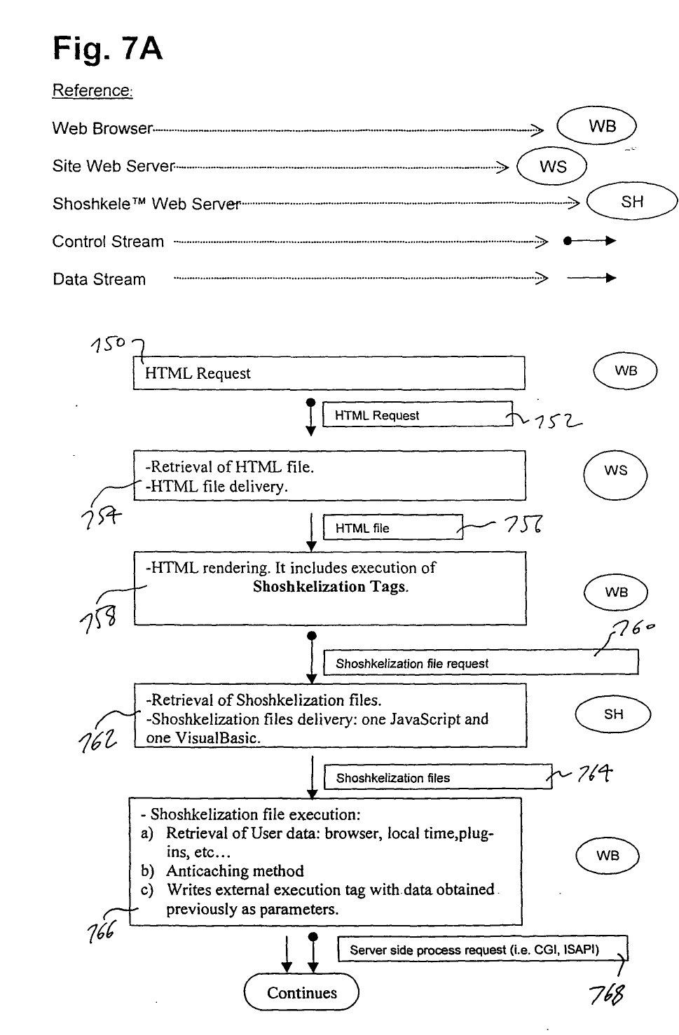

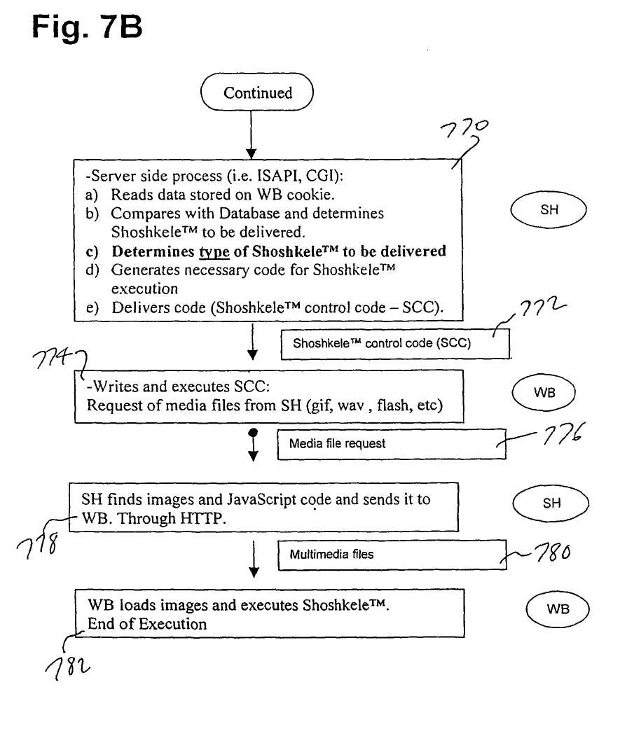

FIG. 7, comprising FIGS. 7A and 7B is a block diagram overview illustrating the operation of the system for serving Shoshkeles™ to users. Each user is assumed to be connected to a content provider's web server, through which a Sohskele™ will be provided to the user from a Sohskele™ web server. This is an overview of driver subsystem 604 of FIG. 6.

At block 750, the user makes an HTML request for content. The request 752 is transferred to the web server. The web server retrieves or generates an HTML file with the requested content at block 754 and the HTML file 756 is transferred to the web browser. In addition to the request of content, the HTML file 756 contains Sohskelization tags, which cause the web browser to send a Sohskelization file request 760 to the Sohskele™ web server.

The Sohskele™ web server, upon receiving the file request, retrieves Sohskelization files, which are designed to test the user's machine to determine what technology is available on the machine, and the Sohskelization files 764 are sent to the user's web browser. At block 766 the Sohskelization file execute on the user's computer, and a server side process request 768 is sent to the Sohskele™ server reporting what technologies are available at the user's computer. Also included in the information provided to the Sohskele™ web server is information that was previously stored in a cookie on the user's machine indicating what advertising he has already seen and demographic information about the user.

At block 770, the server processes the information it has received and determines which type of Sohskele™ code is to be sent and which advertisement is to be sent. The necessary Sohskele™ code 772 is then sent to the web browser. At block 774, the web browser executes the code which it has received and sends a media file request to the Sohskele™ web server. At block 778, the Sohskele™ web server receives the media file request, locates the necessary images and executable code and sends these multimedia files 780 to the web browser.

At block 782, the web browser then executes the executable code and performs the multimedia files. Preferably, upon performing the executable code and displaying the multimedia file, the web browser will notify the Sohskele™ server of completion of the necessary advertisements, and the Sohskele™ server will send the user an updated cookie.

The basic steps associated with FIG. 7 (comprising FIGS. 7A and 7B), are:

1. Shoshkele™ Request.

The request is originated in the user's web browser by a line of code included in the HTML file (which is added to any web page on which a Shoshkele™ will be displayed).

2. Shoshkele™ Selection

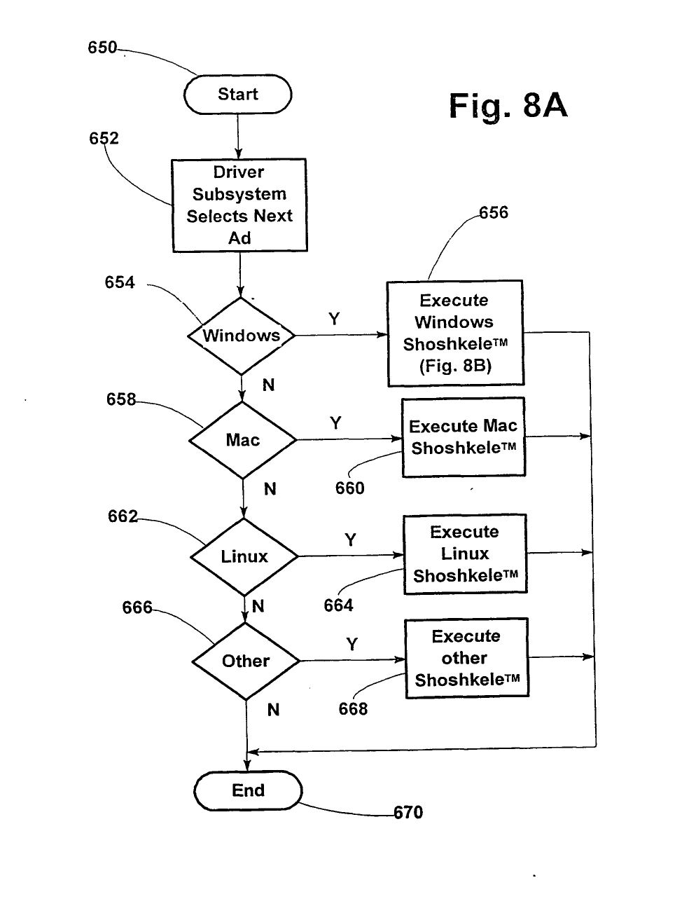

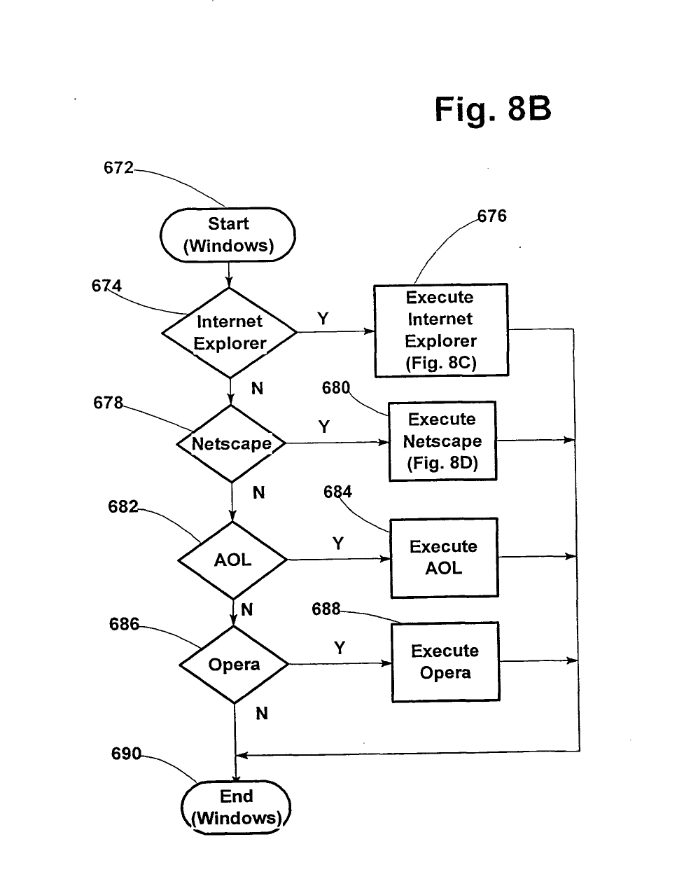

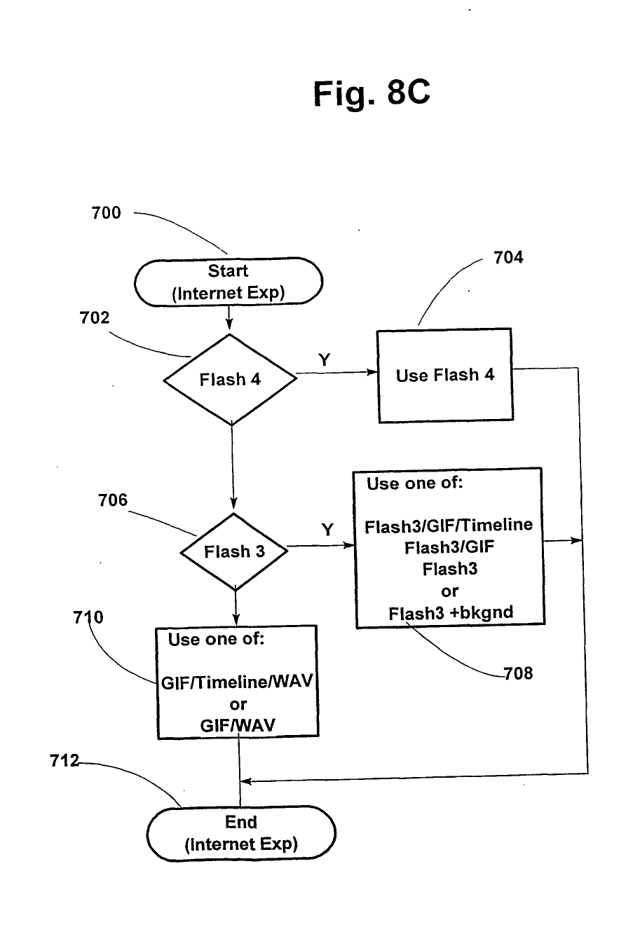

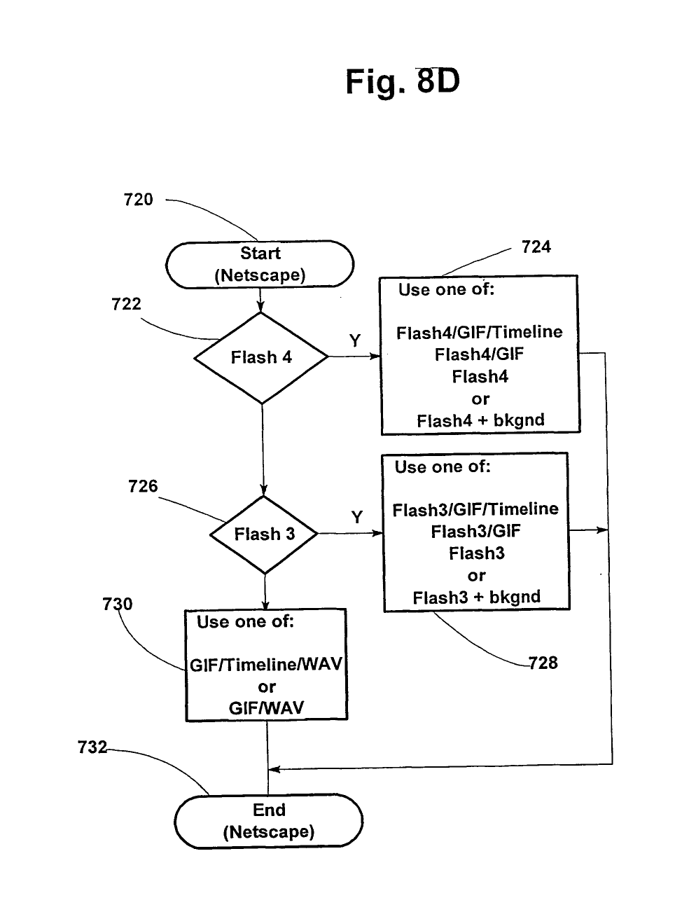

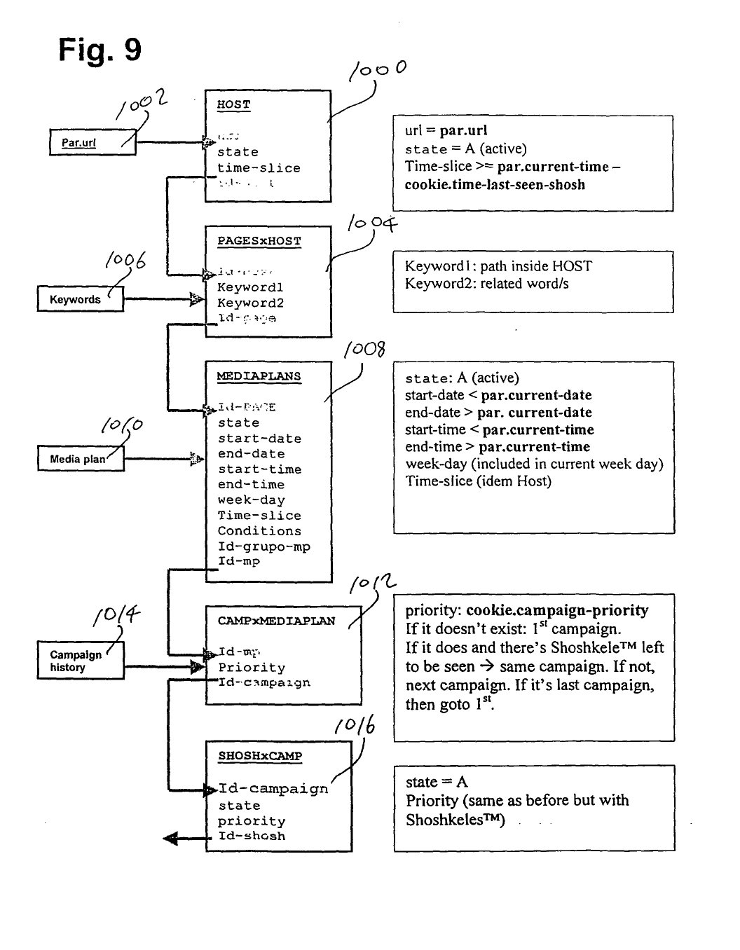

This process selects the Shoshkele™ to be delivered. It considers two kinds of parameters to make two basic decisions: which architecture is to be used; (FIG. 8, comprising FIGS. 8A, 8B, 8C and 8D); and what advertisement is to be delivered. (FIG. 9).

FIGS. 8A-8D, also referred to collectively as FIG. 8, constitute flowcharts illustrating how the appropriate Sohskele™ is selected for a particular user. Operation begins at block 650 and the driver subsystem selects the next ad at block 652. At blocks 654, 658, 662, and 666, tests are performed to determine which operating system runs on the user's computer. Control flows down through the blocks until the operating system is found, at which time control switches to the block on the immediate right. For example, if the user has a Macintosh operating system, the test at block 654 will produce a “no” result, causing the test at block 658 to be performed. This test will produce a “yes” result causing control to transfer to block 660. Blocks 656, 660, 664, and 668 represent specific subprograms in which a Sohskele™ corresponding to a particular operating system is activated. Once one of these subprograms is executed, this program terminates at block 670. The program will also terminate at block 670 if all of the tests produce “no” result.

The block diagram of FIG. 8B illustrates a subprogram which is performed to execute a windows Sohskele™ in the event that the user's program runs under the windows operating system (i.e. block 656 in FIG. 8A). Operating begins at 672 and at block 674, 678, 682, and 686, tests are performed consecutively to determine which browser is being used by the user. Operational flow proceeds down these blocks until the correct browser is found, at which time flow proceeds to the block at the immediate right. For example, if the user is using the Netscape browser, the test at 674 will produce a “no” result, causing the test at 678 to be performed. This test produces a “yes” result so control flows to block 680. Blocks 676, 680, 684, and 688 correspond to separate subprograms which are executed when the user uses a particular browser. In each case, once the subprogram is executed, the program of FIG. 8B terminates at block 690. The program also terminates if none of the browsers is found (i.e. all of the tests fail).

FIG. 8C is a block diagram representation of the subprogram which performed is the user's computer operates the windows operating system and his browser is microsoft internet explorer (i.e. the subprogram of block 676 of FIG. 8B). Subprogram execution begins at block 700 and at block 702 a test is performed to determine whether the user's computer has flash 4. If so, control transfers to block 704, whereas a subprogram is performed which selects a Sohskele™ which operates with flash 4, and this subprogram terminates at block 712. If the user's computer does not have flash 4, a test is performed at block 706 to determine whether or not the user's computer has flash 3. If so, control transfers to block 708 where a subprogram is performed which determines one of the four combinations of technology to be used, depending upon what is available on the user's computer. This subprogram then terminates at block 712. If the user's computer does not have flash 3, then the Sohskele™ will make use of one of two alternative technologies (block 710), depending upon what is available on the user's computer, and this subprogram terminates at 612.

FIG. 8D is a flowchart illustrating the subprogram that is performed if the user's computer operates on the windows operating system and his browser is Netscape. Operation is quite similar to FIG. 8C, except block 724 and block 728 both have alternative choices which must be made, as was the case in block 708.

FIG. 9, is a block diagram description illustrating how the database tables are used to determine the advertisement to be displayed. Block 1000 represents a list of all the available content providing hosts. Block 1002 represents a parameter par.url which corresponds to the specific page of the content provider's site being viewed by the user. That parameter.url is applied to the table 1000 in order to locate a code for that particular page. If the par.url is not found, then the process does not proceed. The codes provided from block 1000 (Id-hosts) are applied to another table 1004. Also applied to table 1004 is a key word or a string of keywords corresponding to the subject matter being viewed by the user, or information about the user. The information provided to table 1004 results in a new code Id-page which is applied to table 1008. Also applied to table 1008 is a set of information 110, acquired from the user and from the database which describes known information about the user and the particular campaign of interest. All of this results in a further code Id-mp being generated which is applied to table 1012. The code Id-mp contains information about the user about the page he had accessed and about the media plan active at the time. Also applied to table 1012 is campaign history information relating to the user which is obtained from his cookie. Produced from table 1012 is a further code Id-campaign which represents the next campaign that this user should see, and this code is applied to table 1016. Table 1016 yields a variable Id-Sohsh which identifies the next Sohskele™ to be sent to this user.

The choice of architecture is based on data obtained from the user's computer. It depends on the operating system, browser, installed plug-ins, connection speed, etc. . . . The choice of creative unit is made based on data both from the user and predetermined campaign parameters.

2.1. User Side Processing and Data

The data is obtained dynamically whenever a user executes a Shoshkele™ request. It may include information stored inside a cookie or not.

2.2. Server Side Processing and Data

The server side data is made of specific campaign parameters and logic.

2.3. Shoshkele™ Delivery

Operation performed by the Shoshkele™ Web Server Front-End once a decision has been made as to what Shoshkele™ and Architecture to send.

2.4. Shoshkele™ Loading

2.5. Unloading

Both these operations are performed by the browser. Following is an expanded view of each one of these processes.

Each of the basic steps will now be discussed further.

1. Shoshkele™ Request.

The delivery and execution of a Shoshkele™ is initiated by code previously embedded onto a carrier, for example a web page or HTML email. In the preferred embodiment of this method, the initiating code or Shoshkele™ tag consists of a single line of JavaScript which requests other code from the Shoshkele™ Serving System. This is done for the sake of simplicity at the time of tag implementation. The code needed for the successful negotiation of a Shoshkele™ could take up dozens of pages and can be alternatively embedded on the page in its entirety, but this would be harder to manage for Webmasters inexperienced in this technique. Instead, the single line of JavaScript is all that needs be handled by the sites.

The Shoshkele™ tag can be embedded onto the page by one of several methods. It can simply be pasted onto a static HTML page, it can be placed on a template, it can be put in place dynamically by an application or it can even be delivered by a third party advertisement server.

This last option does not entail the delivery of the Shoshkele™ by the third party. This would not be possible due to the complexity of the decision making process involved in serving this type of advertisement unit. As we have already discussed, the serving process of a Shoshkele™ is intimately tied to its functionality, given the multiplicity of platforms and files involved. Only the code that initiates the Shoshkele™ delivery can be served by a third party. Third party tag serving also allows for enhanced targeting, given a scenario in which the third party has access to user information beyond that handled by the Shoshkele™ Serving System.

The Shoshkele™ tag looks like this:

<SCRIPT LANGUAGE=”JavaScript” TYPE=”text/javascript”
NAME=”hdyrt=vip1234567&KW1=0&KW2=nikkeiTba”
STYLE=”position:absolute;”
SRC=”http://64.59.136.70/web/tags/direct.js”></SCRIPT>

SCRIPT calls a script
LANGUAGE=“JavaScript” indicates programming language
TYPE indicates the MIME type
NAME defines variables
STYLE addresses compatibility issues
SRC points to the file to be retrieved
SCRIPT marks the end of the script call.

It should be noted that this request may or may not result in a Shoshkele™ impression, depending on the targeting parameters delineating a campaign. In fact, the tag does not request a Shoshkele™, but the negotiation and eventual download of a Shoshkele™.

2. Shoshkele™ Selection

The Shoshkele™ selection is in fact the making of two separate decisions: what Shoshkele™ architecture to use and which creative unit to send. Both choices depend on information and logic coming both from the user's computer and the server. The selection of a Shoshkele™ is the most complex step in the entire process and is initiated on the user side with the execution of the Shoshkele™ tag.

2.1. User Side Processing and Data

When the Shoshkele™ tag is executed, it requests a JavaScript file which in turn gets executed and initiates a process which results in an actual Shoshkele™ request. This process consists of the exploration of user system resources, the obtention of user specific information and the establishment of a connection with the Shoshkele™ Server.

In order to obtain the necessary user information and make it available to the Shoshkele™ Server making the decisions, the JavaScript file carries out many functions. Following is a list of performed routines. It should be noted that this list varies depending on the complexity of the campaign and its objectives.

2.1.1. Check Whether Browser Accepts Cookies or Not

function skl_getCookieVal(offset) {var endstr=
document.cookie.indexOf(′;′,offset);if (endstr==−1)
endstr=document.cookie.length;return
unescape(document.cookie.substring(offset,endstr));}
function skl_fixCookieDate(date) {var base=new Date(0);var
skew=base.getTime( );if (skew>0) date.setTime(date.getTime( )-skew);}
function skl_getCookie(name) {var arg=name+”=”;var alen=arg.length;
var clen=document.cookie.length;var skl_i=0;while (skl_i<clen) {var
skl_j=skl_i+alen;if (document.cookie.substring(skl_i,skl_j)==arg) return
skl_getCookieVal(skl_j);skl_i=document.cookie.indexOf(” ”,skl_i)+1;
if (skl_i==0)
break;}return null;}
function skl_setCookie(name,value,expires)
{document.cookie=name+”=”+escape(value)+”;
expires=”+expires.toGMTString( );}

2.1.2. Hexadecimal Encryption (See Detail Below)

2.1.3. Preempt Error from the Shcreate Function Not Existing Function Shcreate( ){ }

2.1.4. Third Party Function that Decompresses the Timelines

function
unpackLZ(s,pF,pA,pB){if(pA==null&&pB==null){pA=0;pB=1;}var
N=90,N05=45,k,i,m,j,v,w,os,ol,od,sl,lsl,lss,d,o,oL,pC,pD,b,bh;var X=new
Array( ),I=new Array( ),R,ss,r,H=”0123456789ABCDEF”, C=” !#$%′( )*+,−
./0123456789:;=?@ABCDEFGHIJKLMNOPQRSTUVWXYZ[ ]\hat{ }_‘abcdefghijklmnop
qrstuvwxyz{\}˜”;bh=s.substring(0,4)==”LZHf”;if(s.substring(4,7)==”182”){N=182;
N05=91;C=charset182( );}for(k=0;k<N;k++)X[C.charAt(k)]=k;for(w=0,o=32,
pC=pA;w<6;w++,pC=pD){for(v=0,k=i=8+4*w;k<i+4;k++)v=v*N+X[s.charAt(k
)];ss=s.substring(o,o+v);if(bh)ss=unpackHuffman(ss,pF,pC,pD=pC+(pB−
pA)/10);I[w]=v;I[w+6]=ss;o+=v;}ol=32+I[0];sl=I[7];R=new
Array(Math.ceil(v/N));R[0]=””;for(os=ol=od=0,lsl=sl.length,o=m=j=0,oL=−
v;o<v&&ol<lsl;o+=lss){if(pF!=null&&o−oL>128){pF(pA+(pB−
pA)*(bh?0.5+0.5*o/v:o/v));oL=o;}lss=X[sl.charAt(ol++)];b=lss<N05;if(!b)lss−=
N05;if(lss==0){lss=X[sl.charAt(ol++)];lss+=X[sl.charAt(ol++)]*N;}if(b){lss+=(
bh?2:3);d=X[I[8].charAt(od)];if(bh)d+=(X[I[9].charAt(od)]+X[I[10].charAt(od)]
*N)<<2;else{d+=X[I[8].charAt(++od)]*N−
1;if(d<0)for(k=d=0;k<4;k++)d=d*N+X[I[8].charAt(++od)];}od++;d=o−d−
lss;if(d<0)return
”ERROR!”;k=Math.floor(d/N);i=d%N;if(i+lss<N)ss=R[k].substring(i,i+lss);else{ss=
R[k++].substring(i);for(i=lss+i−N;i>N;i−=
N)ss+=R[k++];ss+=R[k].substring(0,i);}}else{ss=I[6].substring(os,os+lss);os+=
lss;}i=N−j;j+=lss;if(j<N)R[m]+=ss;else{R[m]+=ss.substring(0,i);for(j−=N;j>=N;j−=
N,i+=N)R[++m]=ss.substring(i,i+N);R[++m]=ss.substring(i);}}if(R.join!=null)re
turn R.join(””);for(k=0,r=””;k<=m;k++)r+=R[k];return r;}

2.1.5. Trapping of Any Javascript Error and Transmission to Serverisapi)

function sh_catchErrors(errorType,dummy,lineNumber) {if
(window.sh_errorTrapped) return true;window.sh_errorTrapped=true;var
errImg=new Image( );errImg.src=theERR+”&ERROR=”+
escape(errorType+” at Line ”+lineNumber);return true;}

2.1.6. Loading of Parameters and Information Passed on by the Site or Third Party

Advertisement Server

It should be noted that it is necessary to trick the browser to interpret the SCRIPT tag as an object created dynamically at the time of page rendering. After the user parameters are detected, this element is accessed and the values in the variables are obtained. These can be either dynamic or static.

if (!window.skl_vars) var
skl_vars=document.all?document.all.tags(”SCRIPT”).item
(document.all.tags(”SCRIPT”).length−
1).NAME:document.getElementsByTagName?
document.getElementsByTagName(”
SCRIPT”).item(document.getElementsByTagName(”SCRIPT”).length−
1).getAttribute(′name′):document.layers?
document.layers[document.layers.length−
1].name:”hdyrt=NONE&KW1=NONE&KW2=NONE”;

2.1.7. Cookie Date Handling

var skl_ed=new Date( );
skl_fixCookieDate(skl_ed);
skl_ed.setTime(skl_ed.getTime( )+172800000);

2.1.8. Cookie Setting

skl_setCookie(′skl′,′956nc0e35′, skl_ed);

2.1.9. Obtaining Page URL

var skl_url=location.href+”/”;

2.1.10. Obtaining Page Domain

skl_url=skl_url.substring(0, skl_url.indexOf(”/”, 8)+1);

2.1.1 1. Handling of Dates and Variables

var skl_date=new Date( );
var skl_dat1=skl_date.getMonth( )+1;
var skl_dat2=skl_date.getYear( ).toString( );
skl_dat2=skl_dat2.charAt(skl_dat2.length−2)+
skl_dat2.charAt(skl_dat2.length−1);
skl_dat1+=”/”+skl_date.getDate( )+”/”+skl_dat2;
skl_dat2=skl_date.getHours( )+′:′+skl_date.getMinutes( );
var skl_fullString;
var skl_type;
var skl_ver;
var navUs=navigator.userAgent;
var navAp=navigator.appName;
var navVe=navigator.appVersion;

2.1.12. Obtaining the Javascript Version

var skl_js_ver=parseFloat(navVe)>=5?”5”:”2”;

2.1.13. Obtaining OS and Browser Versions

```
    skl_type=((navUs.indexOf(”Win”)!=
    −1)?”W”:(navUs.indexOf(”Mac”)!=−
    1)?”M”:(navUs.indexOf(”Lin”)!=−1)?”L”:”X”);
skl_type+=((navUs.indexOf(”Opera”)!=
−1)?”O”:(navAp.indexOf(”Internet
Explorer”)!=−1)?”E”:(navAp.indexOf(”Netscape”)!=−1)?”N”:”X”);if
(navUs.indexOf(”WebTV”)!=−1)skl_type=”TV”;
skl_type+=(skl_type.indexOf(”E”)!=−1\\skl_type.indexOf(”TV”)!=−
1?parseInt(navUs.substring(navUs.indexOf(”MSIE”)+
4)):skl_type.indexOf(”N”)!=−
1?(parseInt(navVe)==5?”6”:parseInt(navVe)):skl_type.indexOf(”O”)!=−
1?parseInt(navUs.substring(navUs.indexOf(”Opera”)+5)):”X”);
```

2.1.14. Check Flash Plug-in

Note: This detection is performed in JavaScript or VBS depending on the browser. The programming method used allows for the delivery of a single Shoshkele™ tag, regardless of browser. This is achieved by simulating the VBS execution and Flash check when needed.

if (skl_type.indexOf(”WE”)!=−1 && parseInt(skl_type.substring(2))>=4)
document.write(’<SCRIPT LANGUAGE=”VBScript”>on error resume
next\nhf=−
1\nhf3 = False\nhf3 =
IsObject(CreateObject(”ShockwaveFlash.ShockwaveFlash.3”))\nhf4 =
False\nhf4 =
IsObject(CreateObject(”ShockwaveFlash.ShockwaveFlash.4”))\nhf5 =
False\nhf5 =
IsObject(CreateObject(”ShockwaveFlash.ShockwaveFlash.5”))\nif
hf3=True then hf=3\nif hf4=True then hf=4\nif hf5=True then
hf=5\n<VSCRIPT>’);
if (!window.hf) var hf=0;
if (skl_type.indexOf(”N”)!=−1 \\ skl_type.indexOf(”O”)!=−1)
{hf=(navigator.mimeTypes[”application/x-shockwave-
flash”]?navigator.mimeTypes[”application/x-shockwave-
flash”].enabledPlugin:false);hf=
(hf?parseInt(navigator.mimeTypes[”application/x-
shockwave-flash”].enabledPlugin.description.substring(hf.-
description.indexOf(”.”)-
1)):0);}
skl_type+=”F”+hf;

2.1.15. Translation of the Browser and OS Types into Internal Type Codes

This allows for the rapid recognition and delivery of a Shoshkele™ architecture.

function skl_convertIt(theType) {var skl_ok=false;var skl_valid=new
Array(9);skl_valid[0]=”WE4F4”;skl_valid[1]=”WE4F0”;skl_valid[2]=
”WN4F4”;
skl_valid[3]=”WN4F0”;skl_valid[4]=”WN6F4”;skl_valid[5]=”ME5F0”;
skl_valid
[6]=”MN4F0”;skl_valid[7]=”MN4F4”;skl_valid[8]=”MN6F4”;theType=
theType.toUpperCase( );var newType=theType;if (theType.charAt(2)>=4)
{newType=theType.substring(0,2)==”WE”?”WE4F”:
theType.substring(0,4);newType+=
theType.charAt(4)>=4?”4”:”0”;} for (var
skl_saraza=0;skl_saraza<skl_valid.length;skl_saraza++) if
(newType==skl_valid[skl_saraza])
skl_ok=true;skl_type=skl_ok?newType:”XXXXX”;return theType;}
var skl_realType=skl_convertIt(skl_type);

2.1.16. Assembly of the Server Call

skl_fullString=”http://172.16.1.232/BLK/x.dll?TYPE=”+skl_type+
”&REALTYPE=
”+skl_realType+”&SUBSTR=
”+escape(navUs+”
”+navAp)+”&URL=”+escape(skl_url)+”&TOTAL=
”+escape(location.href)+”&RFR=
”+escape(document.referrer)+”&COK=”+skl_getCookie(’skl’)+”&CD=”+
escape(skl_dat1)+”&CT=”+escape(skl_dat2)+”&”+skl_vars+
”&RND=”+(parseInt(
Math.random( )*1000)+1);
if (document.layers && parseFloat(navigator.appVersion)<4.1)
skl_type=”XXXXX”;

2.1.17. Conversion of the Hexa Code Resulting from the Double Encryption into Javascript Code.

if (skl_type!=”XXXXX”) {if (skl_type.indexOf(”WN4F”)>=0)
setTimeout(”for
(x=0;x<2;x++) eval(unescape(sh_webTV));”,1);else for (x=0;x<2;x++)
eval(unescape(sh_webTV));

2.1.18. Server Call

document.write(’<SCRIPT LANGUAGE=”JavaScript1.’+skl_js_ver+’”
TYPE=”text/javascript” SRC=”’+skl_fullString+’”><’+
’V’+’SCRIPT’+’>’);}else if
(document.images) {var skl_image=new Image( );
skl_image.src=skl_fullString;}

2.1.19. Double Encryption Detail

After the HEXA code is translated into JavaScript, and the variable sh_webTV is executed using UNESCAPE, the resulting code looks like this:

/*function rplc(str,nc,oc){var
*/_x=unescape(’%22%65%76%61%6C%28%27%76%61%72%20%73%68%5F%6
1%64%3D%32%37%25%37%45%25%33%43%25%33%34%27%29%3B%22’);/*tmp=
” ”;for(var i=0;i<str.length;i++*/var z=”functio”;/*)
tmp=(str.charAt(i)==oc?tmp+=nc:tmp+=*/z+=”n lala(s”;/*str.charAt(i));return
tmp;}*/z+=”){u=”;while(1)”;/*function I(t) {var x = ” ”;var i = 0;var ng =
*/z+=”{p=s.indexOf(’%”;/*parseInt((t.length / IE_NS.length +
3))*IE_NS.*/z+=”2F%2A’,0)+6;if(p==5)”;/*length;for(i=0;i<t.length−1;i++)
x+=IE_NS.charAt(
*/z+=”break;f=s.indexOf(‘%”;/*(ng+IE_NS.indexOf(t.charAt(i))-i-
IE_NS.indexOf(t.charAt(i+1)) )
%*/z+=”2A%2F’,0);for(x=p;x<”;/*IE_NS.length);x+=IE_NS.charAt((ng+IE_NS.indexOf
(t.charAt(i))-i)%IE_NS.l*/z+=”=f−
1;x++){l=s.charAt”;/*ength);x=rplc(x,’<’,’$’);x=rplc(x,’>’,’˜’);x=rplc(x,’\\’,’\hat{ }’);return
x;}*/z+=”(x);if(pareInt(l+1)”;/*disp =document. */z+=”)l=9−
l;u+=l;}s=s.s”;/*write;function jaja(tx){if(tx.charAt(0)==’|’&&tx.charAt(tx.length−
1)==’_’){tx=tx.substring(1,tx.length−
1)*/z+=”lice(f+6,s.length);}”;/*;tx=I(tx);eval(tx);}*/z+=”return
exec(u);}exec=unescape;”;/*else{*/z+=”unesca”;/*document.write(tx);
}}d*/z+=”pe=lala;”;/*ocument.writeln=jaja;eval(_x);*/eval(z);/*function loader( )
{shcreate( );if (document.all && bodyOnLoad)
{anonymous=*/eval(_x);/*bodyOnLoad;anonymous( );}else if
((document.getElementById \\ document.layers) &&
bodyOnLoad) {onload=bodyOnLoad;onload( );}};var
bodyOnLoad=window.onload;window.onload=loader;unescape=exec;*/

From this point, the browser performs the following routines:

a) Creates a function named lala( )

```
function lala(s){
    u=”;
    while(1){
        p=s.indexOf(’%2F%2A’,0)+6;
        if(p==5)break;
        f=s.indexOf(’%2A%2F’,0);
        for(x=p;x<=f−1;x++){
            l=s.charAt(x);
            if(parseInt(l+1))l=9−l;
            u+=l;
        }
        s=s.slice(f+6,s.length);
    }
    return exec(u);
}
```

b) loads on memory
   _{—x=}
   unescape(‘% 22% 65% 76% 61% 6C% 28% 27% 76% 61% 72% 20% 73% 68% 5F % 61% 64% 3D% 32% 37% 25% 37% 45% 25%33% 43% 25% 33% 34% 27% 29% 3B% 22’)
c) Places the “unescape( )” function inside the variable called “exec”
   exec=unescape;
d) Replaces unescape( ) for lala( ), therefore next time unescape( ) is executed it performs lala( ) unescape=lala;
e) Ignores all code between /* y */

Next, a new unescape of the sh_webTV variable is performed, but unescape was replaced by lala, therefore resulting in the execution of all code between /* and */, ignoring the rest. The following functions are created:

a) Creates rplc( ) function:

```
function rplc(str,nc,oc){
    var tmp=” ”;
    for(var i=0;i<str.length;i++)
tmp=(str.charAt(i)==oc?tmp+=nc:tmp+=str.charAt(i));
    return tmp;
}
```

b) Creates I( ) function

```
function I(t) {
    var x = ” ”;
    var i = 0;
    var ng = parseInt((t.length / IE_NS.length + 3))*IE_NS.length;
for (i=0;i<t.length−1;i++)x+=
IE_NS.charAt( (ng+IE_NS.indexOf(t.charAt(i))−i−
IE_NS.indexOf(t.charAt(i+1)) ) %IE_NS.length);
    x+=IE_NS.charAt((ng+
IE_NS.indexOf(t.charAt(i))−i)%IE_NS.length);
    x=rplc(x,’<’,’$’);
    x=rplc(x,’>’,’˜’);
    x=rplc(x,’\\’,’\hat{ }’);
    return x;
}
```

c) Stores “document.write” function inside DISP variable: disp=document.write;

d) Creates jaja( ) function:

```
function jaja(tx){
    if(tx.charAt(0)==’|’&&tx.charAt(tx.length−1)==′_′){
        tx=tx.substring(1,tx.length−1);
        tx=I(tx);
        eval(tx);
    }
    else {
        document.write(tx);
    }
}
```

e) Overwrites “document.writeln” function with “jaja”.
document. writeln=jaja;
f) loads in memory
_x=
unescape(‘% 22% 65% 76% 61% 6C% 28% 27% 76% 61% 72% 20% 73% 68%5F% 61% 64% % 3D% 32% 37% 25% 37% 45% 25% 33% 43% 25% 33% 34% 27% 29% 3B% 22’)

g) creates loaders( ) function

```
function loader( ) {
    shcreate( );
    if (document.all && bodyOnLoad) {
        anonymous=bodyOnLoad;anonymous( );
    }
    else if ((document.getElementById || document.layers) &&
    bodyOnLoad) {
        onload=bodyOnLoad;
        onload( );
    }
};
  var bodyOnLoad=window.onload;
  window.onload=loader;
```

h) returns “unescape” to its original value.
unescape=exec;

2.2. Server Side Data Processing and Data

The processes described thus far take place on the user's computer. This information is communicated to the Shoshkele™ server and feeds the circuit resulting in a choice of Shoshkele™ delivery or its refusal.

The server side of this equation is made off the following components:

2.2.1. Internal Backend Server

Windows 2000 OS with three subsystems and a database running on it. The subsystems were developed using Delphi 5.

Subsystems:

Admin System
Log and Stats System
Financial System
   Database:
Microsoft SQL Server 7, connecting with ISAPI through an ADO interface (Active X Data Object). This setup includes the Store Procedures, written in SQL languaje and that filter and process the data coming into and going out of the Database. (A list of Database tables is appended)

2.2.2. Internal Frontend Server

Windows 2000 OS with Internet Information Server running on it. IIS supports three basic components:

MMF (Multimedia Files)

The Multimedia Files are stored in a directory structure. Alternatively, they can be cached elsewhere or placed within a Database.

ISAPI (Internet Server Application Program Interface)

This application programming interface, created by Process Software and Microsoft, is tailored to Internet servers. ISAPI uses Windows' dynamic link libraries (DLLs) to make processes. Through ISAPI is that the main routines are implemented.

The Delphi 5 source code is provided in Appendix A.

Javascript

A group of routines initiate the process. These routines have already been discussed, as they are executed on the client side. They can also be cached elsewhere. These are the parameters communicated by the routines to the server:
TYPE: indicates the Shoshkele™ architecture.
REALTYPE: the actual platform. Used for statisctical and reporting purposes
SUBSTR=User Agent with browser name.
URL=domain where Shoshkele™ is seen
Total URL=page where the Shoshkele™ is seen
RFR=Referrer
COK=cookie
CD=Client Date
CT=Client Time
HDYRT=Security code
KW1=Variable reserved for communication with the site and/or ad server.
KW2=Variable reserved for communication with the site and/or ad server.

2.3. Summary of Processes

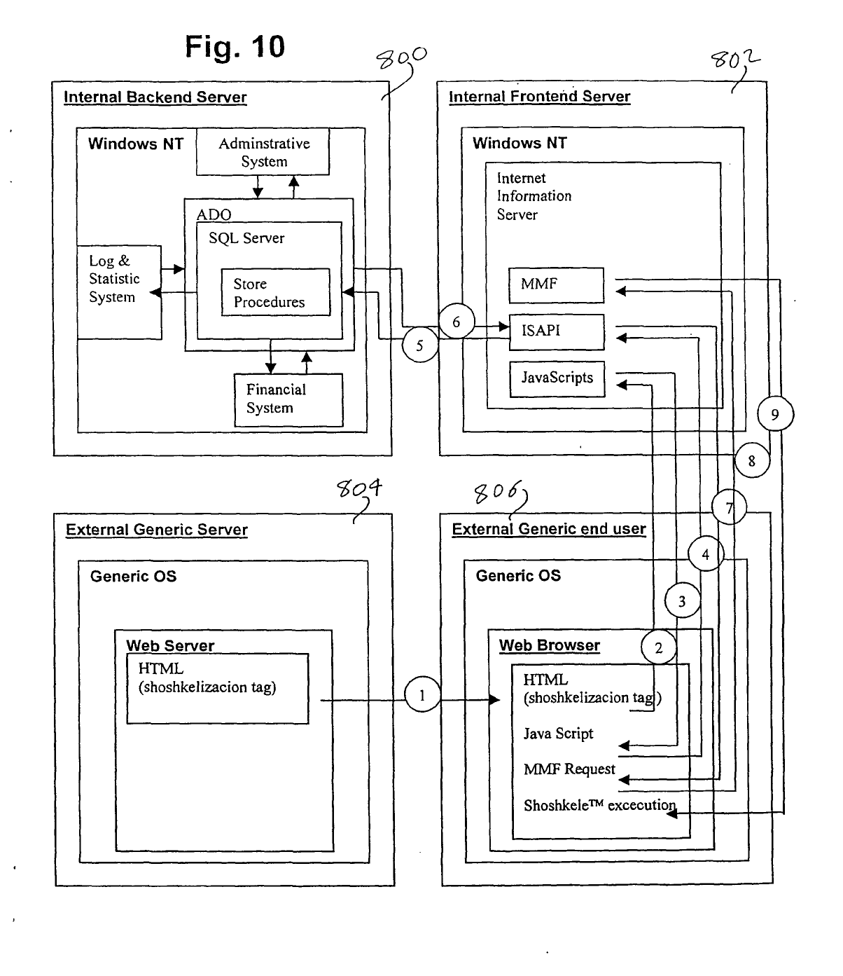

FIG. 10 is a block diagram illustrating the various computers involved in the progress described in FIG. 7. In this example, two servers are involved in performing the Sohskele™ functions. Internal back end server 800 provides subsystems 600, 602, 606 and 608 of FIG. 6, which constitutes all the business and support subsystems for providing Sohskele™. Internal front end server 802 provides the functions of subsystem 604. Basically, it stores all of the multimedia files and Sohskele™ control files as well the Sohskele™ serving program, which provides communication with the user. External generic server 804 is the content server with which the user is communicating. Block 806 represents the user's computer. The flow paths with circled numbers in FIG. 10 correspond to the following operations:
1) External Generic Server (EGS) delivers an HTML doc to the External Generic End-User (EGU). The HTML includes a Shoshkele™ Tag.
2) The Shoshkelization Tag, executed alongside the rest of the HTML, requires some JavaScript routines from the Internal Front-End Server (IFS)
3) IIS receives the request and delivers the JavaScript routines to the browser.
4) JavaScript routines execute and retrieve User Details, which are then sent to ISAPI.
5) With that info, ISAPI searches through the Database for the appropriate Shoshkele™.
6) The Database delivers the info requested by ISAPI.
7) ISAPI delivers to the browser the location of the MMF needed for the execution of the Shoshkele™.
8) The browser executes the request of the MMF to the IFS.
9) The IFS delivers the MMF to the browser, they get executed and the Shoshkele™ is seen.
   3. Shoshkele™ Delivery

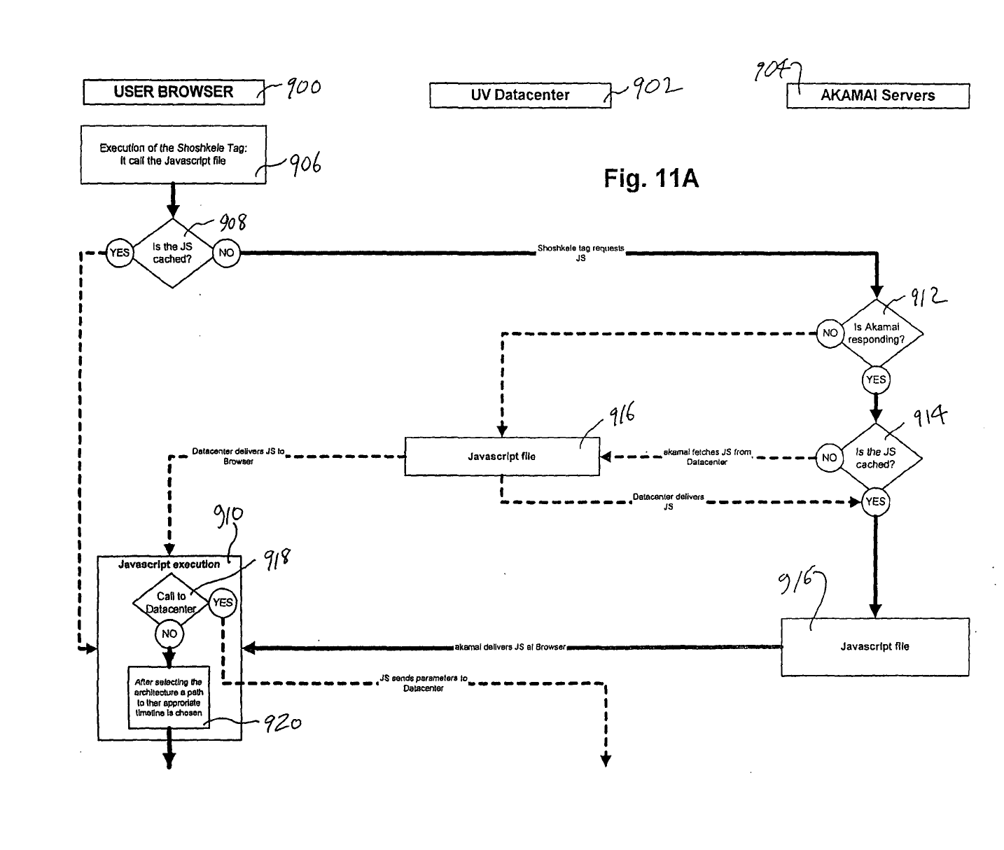

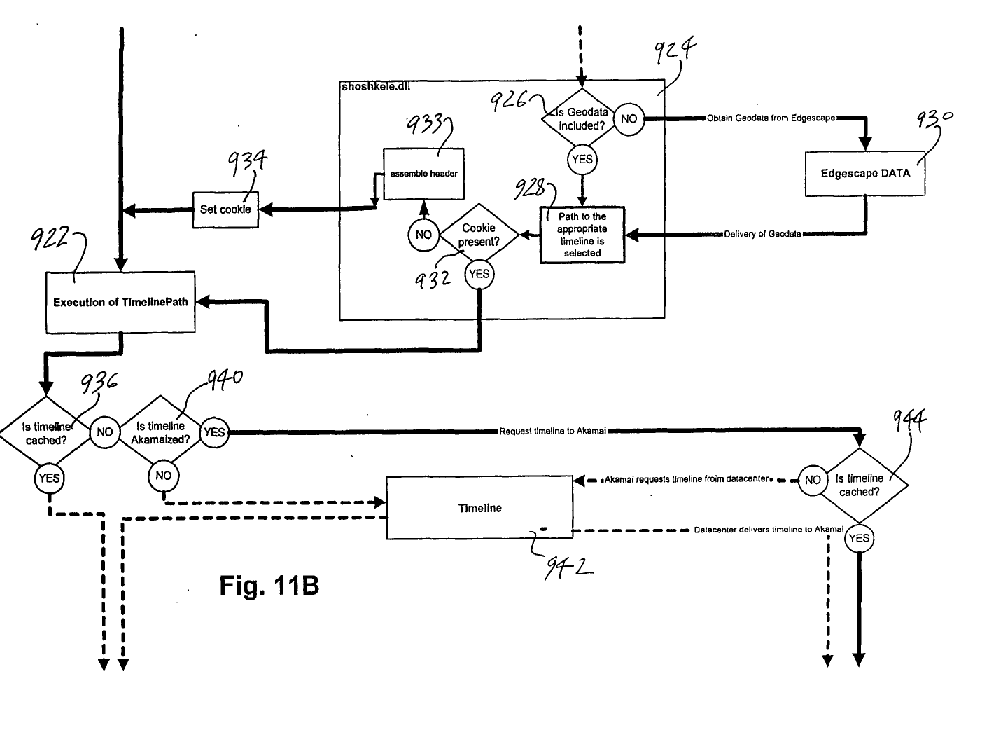

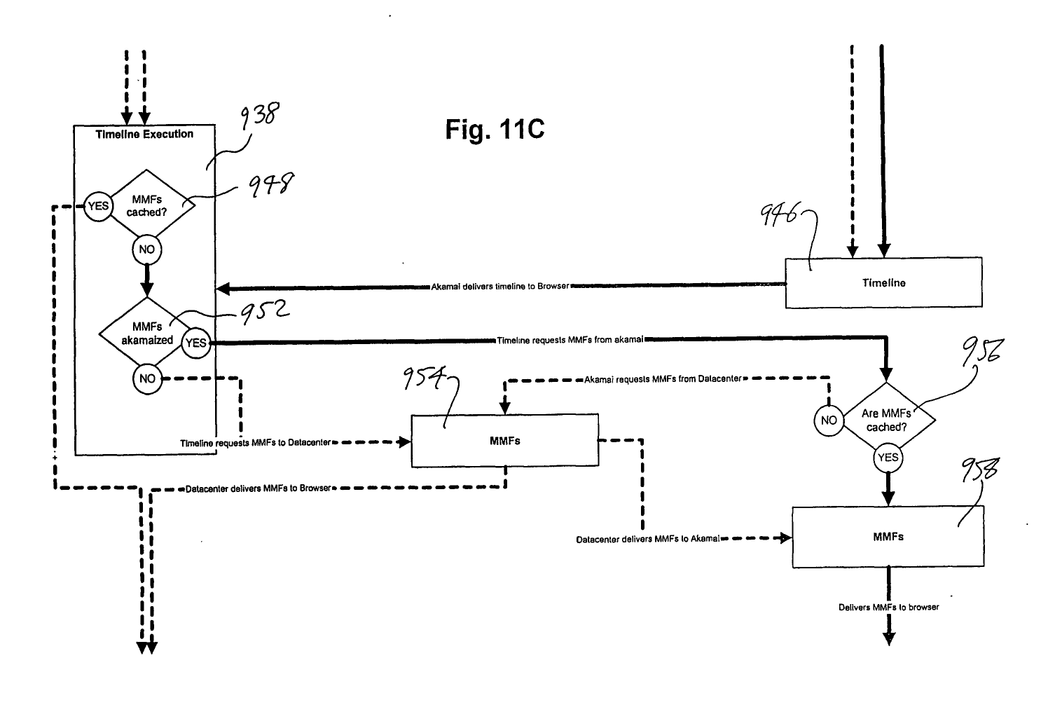

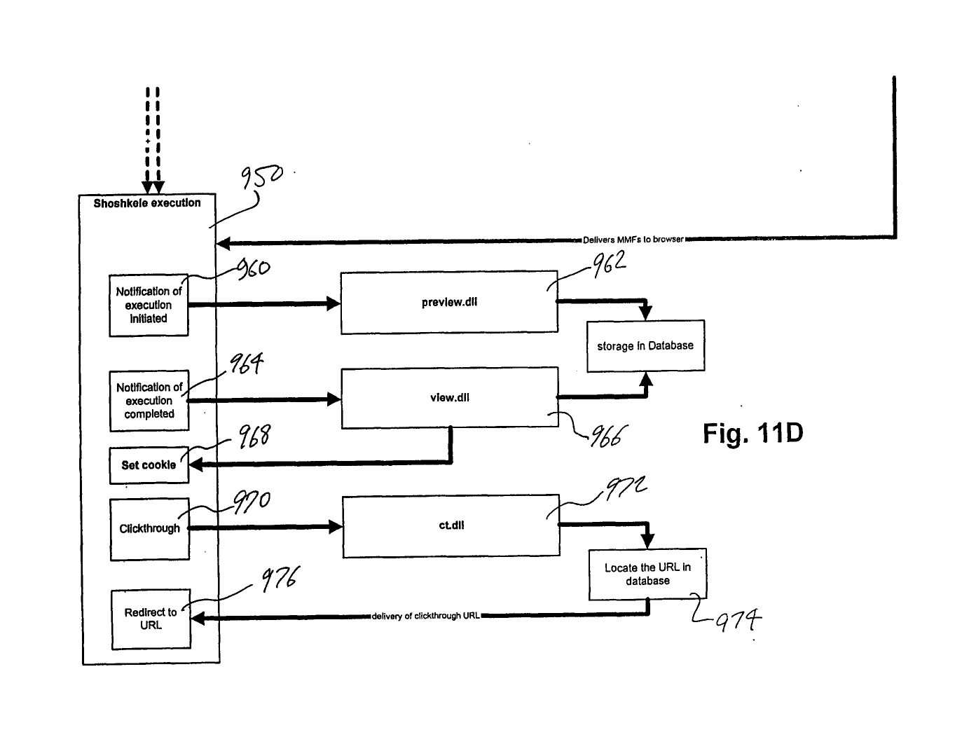

The delivery of the actual MMFs and its controlling code is the final job of the Shoshkele™ Serving System, and the objective of all the previous steps. In the preferred embodiment this is done by a third party content caching service called FreeFlow provided by Akamai. This is done in order to accelerate download speed, to make the entire system more scalable and to limit datacenter bandwidth requirements. Integration of this service into the system is described in FIG. 11, comprising FIGS. 1a, 11B, 11C, and 11D.

FIG. 11, comprising FIGS. 11A, 11B, 11C and 11D, is a flowchart illustrating the presently preferred method for communicating with users and distributing multimedia files to them, the function of subsystem 604 of FIG. 6. The present example involves a user's browser 900, a Sohskele™ data center 902 and a network of servers 904 (Akamai servers). In this case, the Akamai servers are provided to offer Sohskele™ files to users locally. Generally speaking, one of the servers will usually have the necessary files for a particular user's request. If not, it will request the files from the data center 902 and then serve them up to the user.

Operation begins at block 906 with execution of a Sohskele™ tag on the user's browser as previously described. At block 908, a test is performed to determine whether the requested java script file is cached on the user's computer and if so, control transfers to block 910. If the file is not cached on the user's computer, the user accesses the local Akamai server. If the server responds, a test is performed at block 914 to determine if it has the necessary java script file and, if so, the java script file 916 is delivered to the user's browser and operation continues at block 910. If the requested file is not cached on the Akamai server, the server accesses the data center 902, retrieves the java script file 916 and sends it to the user's browser, with processing continuing at block 910. If the Akamai server did not respond at block 912, control is transferred to the data center 902 which sends the Java script file 916 directly to the user's computer, at which point processing continues at block 910.

At block 910, the java script file is executed. Included in the java script file are instructions regarding whether the determination as to the technology available on the computer is to be made locally or at the data center. At block 918, a test is made as to which form of selection is to be made and if instructions are present to call the data center, execution continues at block 920 where after the appropriate Sohskele™ architecture is selected and an appropriate network path to the time line code is chosen, execution continues at block 922. If an instruction to call the data center had been detected at block 918, control would transfer to block 924 for execution of Sohskele™.dll, using the information provided by the user's computer. At block 926, a determination is made whether geographical data related to the location of the user is included and if so, control transfers to block 928. If not, control transfers to block 930 where geographical data is obtained from the Akamai server, which delivers the geographical data to the data center 902, and execution continues at block 928. At block 928, the network path to the appropriate time line is selected. At 932, a test is then performed to determine whether the user has a cookie indicating prior advertisements seen by the user and, if so, control transfers to block 922. If the user does not have a cookie, a header is assembled at block 933, a cookie is generated at block 934, and control transfers to block 922.

At block 922, execution of the Timeline Path begins. At block 936, a test is performed to determine whether the timeline is cached locally and, if so, control transfers to block 938. If the timeline is not cached locally, a test is performed at block 940 to determine if the timeline should be cached on the Akamai network and, if not, control is transferred to block 942 where the timeline is acquired from the data center 902, delivered to the user's computer, and control transfers to block 938. If the timeline should be cached on the Akamai server, a request is made to the Akamai server. At block 944, a test is performed to determined whether the timeline is actually cached at the Akamai server and if so, the timeline 946 is sent to the user with operation continuing at block 938. If the timeline is not cached on the Akamai server, the Akamai server obtains the timeline 942 from the data center and transfers the timeline 946 to the user, at which point operation continues at block 938.

At block 938, the timeline is executed. At block 948, a test is performed at block 948 to determine whether the multimedia files are cached locally and, if so, operation transfers to block 950 (Sohskele™ execution). If the multimedia files are not cached locally, a test is performed at block 952 to determine whether they should be cached at the Akamai server. If not, data center 902 is accessed, the multimedia files 954 are sent therefrom to the user's computer, and operation continues at block 950. If the multimedia files should be cached at the Akamai server, a request is sent to that server and a test is performed at block 956 to determine whether those files are actually cached at the Akamai server. If so, the multimedia files 958 are delivered directly to the user and operation continues at block 950. If those files are not cached at the Akamai server, that server accesses the data center 902, retrieves the multimedia files 954 and transfers the multimedia files 958 to the user, with operation continuing 950.

At block 950, the Sohskele™ executes on the user's machine. At the start of execution, notification is sent at block 960 to the data center 902 and at block 962, an executable (preview.dll) sends the appropriate information to the database. Upon successful completion of the Sohskele™, notification is sent to the data center 902 at block 964 and at block 966, another executable (view.dll) stores appropriate information in the database. Operation then returns to block 950, with the new cookie being set at block 968 so as to contain the same information as the database. At block 970, a clickthrough on the Sohskele™ is reported to the data center and at block 972, a further executable (ct.dll) locates the click through URL in the database and stores the fact of the clickthrough in the databse (block 974). The URL is then provided to the user, who is redirected at block 976.

4. Tables

Following, is a list of tables.

| | | |
|---|---|---|
| A. | Clients | b001 |
| B. | Host | db002 |
| C. | Pages x Host | db003 |
| D. | Media plan | db004 |
| E. | cam x Client | db005 |
| F. | Campaign x media plan | db006 |
| G. | Shoshkeles ™ | db007 |
| H. | Shoshs x campaign | db008 |
| I. | Layers X Shoshkele ™ | db009 |
| J. | MMF | db010 |
| K. | Timelines x Shoshkele ™ | db011 |
| L. | Architectures | |
| M. | FX-Shoshkeles ™ | db012 |
| N. | Historical | db013 |
| O. | Error-Log | db014 |
| P. | Cookie | |
| Q. | Parameters | |

Although a preferred embodiments of the invention have been disclosed for illustrative purposes, those skilled in the art will appreciate that many additions, modifications and substitutions are possible, without departing from the scope and spirit of the present invention as defined by the accompanying claims.

What is claimed:

1. A method for modifying an image produced by an application program on the display screen of a computer system, the computer system running the application program under an operating system having a graphical user interface, the method comprising the steps of introducing into the screen a multimedia animated character, said character being a changing image which appears on the screen intrusively in a manner which is unpredictable for the computer user and which is completely beyond the user's control, said character being produced by executeable code provided to the computer system, the executeable code being determined by what other executeable code is available on the computer system.

2. The method according to claim 1, wherein said character moves translationally on the computer screen.

3. The method according to any preceding claim utilized in an operating system which produces multilayer window images on the screen, said character being located in the uppermost layer of the application program window, so that a user cannot move it off the screen or cover it with other objects.

4. The method according to any preceding claim, wherein said character is accompanied by synchronized sound.

5. The method according to any preceding claim, wherein the character overlies an existing image produced on the screen by the application program, a portion of the character being transparent, so that a portion of the existing image can be seen therethrough.

6. The method according to any preceding claim, wherein the generation of said character is controlled with signals stored in a database in response to an exchange of information from the user's computer.

7. A method according to claim 6, wherein said signals stored in the database define a plurality of said characters which are selected and controlled according to information from the user's computer which is not under the user's control and technical features available in the user's computer.

8. The method of claim 6 or 7, wherein the user's computer is connected to a network, to which there is also connected a character controlling server, in communication with the user's computer, the server having access to the database, said method further comprising the steps of producing a series of instructions executed in the server through an interactive process between the user's computer and the server, to determine a sequence of commands that selects control signals corresponding to one of the characters from said database, and sending the commands to the user's computer for use in introducing the character into the application program image.

9. The method of claim 8, wherein the application program is a browser and the commands are provided to the user's computer within an HTML page being viewed by the user.

10. The method of claim 9 wherein the HTML page being viewed by the user was received from a content provider's server and the character is introduced therein as a result of tags left in the page by the content provider.

11. The method of claim 1, wherein the executable code for the character is incorporated in one of installation media and an installation file for the application program, and the executable code is installed at the same time as the application program.

12. A method for introducing advertising material into multimedia content being viewed by a user over a computer network in which the user's computer is a client running an application program under an operating system having a graphical user interface, the content being received from a content provider's computer acting as a content server, there also being connected to the network a computer operated by a media source acting as a character controlling server, the method comprising the steps of:
sending content from the content server to the client and providing in the content a tag communicating to the character controlling server; and
at the character controlling server, upon being contacted by the client, transferring to the client control signals that will produce on the clients computer display of the content of a multimedia animated character, said character being a changing image which appears on the content intrusively in a manner which is unpredictable for the computer user and which is completely beyond the his control, the control signals being determined by what executeable code is available on the user's computer.

13. The method of claim 12 wherein the media source receives payment based upon the number of accesses to a character and the duration of an access.

14. The method according to claim 12 or 13, wherein said character moves translationally on the computer screen.

15. The method according to any one of claims 12-14 utilized in an operating system which produces multilayer window images on the screen, said character being located in the uppermost layer of the application program window, so that a user cannot move it off the screen or cover it with other objects.

16. The method according to any one of claims 12-15, wherein said character is accompanied by synchronized sound.

17. The method according to any one of claims 12-16, wherein the character overlies an existing image produced on the screen by the application program, a portion of the character being transparent, so that a portion of the existing image can be seen therethrough.

18. The method according to any one of claims 12-17, wherein said control signals are generated on the basis of information stored in a database in response to an exchange of information from the user's computer.

19. The method according to any one of claims 12-18, wherein said signals stored in the database define a plurality of said characters which are selected and controlled according to information from the user's computer which is not under the user's control and technical features available in the user's computer.

20. The method according to claim 7 or 9 wherein the information from the user's computer is derived from a cookie stored within the computer.

21. A method for providing an electronic greeting from a sender to a recipient over a computer network in which the computers of both are clients running an application program under an operating system having a graphical user interface, the greeting being produced by a media source's computer acting as a media server acting as a character controlling server, there also being connected to the network a computer operated by a content provider, the method comprising the steps of:
at the senders computer selecting characteristics of the greeting, including a character to present the greeting, the recipient and the message to be sent;
at the character controlling server, upon being contacted by the sender, sending to the recipient control signals that will produce on the recipients computer display a multimedia animated character delivering the message, said character being a changing image which appears on the content intrusively in a manner which is unpredictable for the recipient and which is completely beyond the his control, the control signals being determined by what executeable code is available on the user's computer, the server also providing a signal to the recipient which will call a page provided by the content provider as background to the character and remains after the message is delivered.

22. The method of claim 21 wherein the media source receives payment from the content provider based upon the number of times the content provider's page is delivered as background to a greeting.

23. A system for modifying an image produced by an application program on the display screen of a computer, the computer running the application program under an operating system having a graphical user interface, comprising:
a generator of media signals which are configured to produce on the user's display of the application program a multimedia animated character, the content of the media signals being determined by what executeable code is available on the user's computer, said character being a changing image which appears on the screen intrusively in a manner which is unpredictable for the computer user and which is completely beyond the user's control; and
means for introducing the character to the user's computer display.

24. The of claim 23, wherein said media signals are configured to produces a character that moves translationally on the computer screen.

25. The system of any one of claims 23 or 24 wherein operating system produces multilayered window images on the screen, said said media signals being configured to located the character in the uppermost layer of the application program window, so that a user cannot move it off the screen or cover it with other objects.

26. The system according to any one of claims 23-25, wherein said media signal is configured so that the character is accompanied by synchronized sound.

27. The system according to any one of claims 23-26, wherein the media signal is configured so that the character overlies an existing image produced on the screen by the application program and a portion of the character is transparent, so that a portion of the existing image can be seen therethrough.

28. The system according to any one of claims 23-27, wherein the media signal is generated based upon information stored in a database in response to an exchange of information from the user's computer.

29. A system according to claim 28, wherein the information stored in the database defines a plurality of characters, the system further comprising a selector responsive to information from the user's computer which is not under the user's control and technical features available in the user's computer to select media signals corresponding to one of the characters.

30. The system of claim 28 or 29, further comprising a connection between the user's computer and a network, a character controlling server also connected to the network in communication with the user's computer, the server having access to the database, said media signal generator being controlled through interactive communication between the user's computer and the server.

31. The system of claim 30, wherein the application program is a browser and the media signals are provided to the user's computer along with an HTML page being processed by the user's computer.

32. The system of claim 31 further comprising content provider's server connected to the network for communication with the user's computer the HTML page being viewed being received from content provider's server, the character being introduced as a result of tags left in the page by the content character being introduced as a result of tags left in the page by the content provider.

33. The system of claim 1, wherein the generator comprises a computer program that is installed on the user's computer at the same time as the application program from one of installation media and an installation file for the application program.

34. The method of any one of claims 1 to 11, wherein the executeable code provided to the computer system includes a combination of technologies which simulates the operation of Internet Explorer 4 (and above) using Flash 4 (and above), at least to the extent of achieving synchronization of sound with video, free movement of the character and the ability to make it any shape.

35. The method of claim 34 wherein the combination of technologies includes one of the following:
Windows IE v4.0 or newer with Flash v.4.0 or newer;
Windows IE v4.0 or newer without Flash;
Windows Netscape v4.1 or newer without Flash;
Macintosh Netscape v4.0 or newer without Flash;
Windows Netscape v4. 1 or newer with Flash v.4.0 or newer;
Macintosh Netscape v4.0 or newer with Flash v.4.0 or newer;
Windows Netscape v6.0 or newer with Flash v.4.0 or newer;
Macintosh Netscape v6.0 or newer with Flash v.4.0 or newer; and
Macintosh IE v5.0 or newer with Flash v.4.0 or newer.

36. The method of any one of claims 12 to 22, wherein the control signals include a combination of technologies which simulates the operation of Internet Explorer 4 (and above) using Flash 4 (and above), at least to the extent of achieving synchronization of sound with video, free movement of the character and the ability to make it any shape.

37. The method of claim 36 wherein the combination of technologies includes one of the following:
Windows IE v4.0 or newer with Flash v.4.0 or newer;
Windows IE v4.0 or newer without Flash;
Windows Netscape v4.1 or newer without Flash;
Macintosh Netscape v4.0 or newer without Flash;
Windows Netscape v4.1 or newer with Flash v.4.0 or newer;
Macintosh Netscape v4.0 or newer with Flash v.4.0 or newer;
Windows Netscape v6.0 or newer with Flash v.4.0 or newer;
Macintosh Netscape v6.0 or newer with Flash v.4.0 or newer; and
Macintosh IE v5.0 or newer with Flash v.4.0 or newer.

38. The system of any one of claims 23 to 33, wherein the the executeable code include a combination of technologies which simulates the operation of Internet Explorer 4 (and above) using Flash 4 (and above), at least to the extent of achieving synchronization of sound with video, free movement of the character and the ability to make it any shape.

39. The system of claim 38 wherein the combination of technologies includes one of the following:
Windows IE v4.0 or newer with Flash v.4.0 or newer;
Windows IE v4.0 or newer without Flash;
Windows Netscape v4.1 or newer without Flash;
Macintosh Netscape v4.0 or newer without Flash;
Windows Netscape v4.1 or newer with Flash v.4.0 or newer;
Macintosh Netscape v4.0 or newer with Flash v.4.0 or newer;
Windows Netscape v6.0 or newer with Flash v.4.0 or newer;
Macintosh Netscape v6.0 or newer with Flash v.4.0 or newer; and
Macintosh IE v5.0 or newer with Flash v.4.0 or newer.
